(19) United States
(12) Patent Application Publication
(10) Pub. No.: US 2019/0011847 A1
(43) Pub. Date: Jan. 10, 2019

(54) TONER, TONER STORED UNIT, AND IMAGE FORMING APPARATUS

(71) Applicants: Satoshi OGAWA, Nara (JP); Masahiro SEKI, Shizuoka (JP); Yoshitaka SEKIGUCHI, Shizuoka (JP); Tohru MORIYA, Shizuoka (JP)

(72) Inventors: Satoshi OGAWA, Nara (JP); Masahiro SEKI, Shizuoka (JP); Yoshitaka SEKIGUCHI, Shizuoka (JP); Tohru MORIYA, Shizuoka (JP)

(21) Appl. No.: 16/131,538

(22) Filed: Sep. 14, 2018

Related U.S. Application Data
(63) Continuation of application No. PCT/JP2017/007056, filed on Feb. 24, 2017.

(30) Foreign Application Priority Data
Mar. 15, 2016 (JP) 2016-051553
Mar. 15, 2016 (JP) 2016-051558
Mar. 15, 2016 (JP) 2016-051573

(51) Int. Cl. G03G 9/097; G03G 9/087

(52) U.S. Cl. CPC G03G 9/09783; G03G 9/08755

(57) ABSTRACT

Provided is a toner including a binder resin, wherein the toner includes a THF-insoluble component in an amount of from 10% by mass through 40% by mass, a molecular weight distribution of a THF-soluble component of the toner measured by gel permeation chromatography (GPC) has a main peak between 10,000 and 16,000, and a half value width of the main peak is a molecular weight of from 60,000 through 90,000, and the THF-soluble component of the toner includes a component having a molecular weight of 2,000 or less in an amount of from 15.0% by mass through 25.0% by mass, and a component having a molecular weight of 100,000 or greater in an amount of 10.0% by mass or less as measured by GPC.

### CROSS-REFERENCE TO RELATED APPLICATIONS

The present application is a continuation application of International Application No. PCT/JP2017/007056, filed Feb. 24, 2017, which claims priority to Japanese Patent Application No. 2016-051553, filed Mar. 15, 2016, Japanese Patent Application No. 2016-051558, filed Mar. 15, 2016, and Japanese Patent Application No. 2016-051573, filed Mar. 15, 2016. The contents of these applications are incorporated herein by reference in their entirety.

### BACKGROUND OF THE INVENTION

### Field of the Invention

The present disclosure relates to a toner, a toner stored unit, and an image forming apparatus.

### Description of the Related Art

There is a recent tendency that the smaller size and the longer service life are desired for printers of one-component development. In addition, low-temperature fixing has been realized. As the above-mentioned properties have been developed, it is an urgent task to secure improvement of stress resistance of a toner and excellent fixability of the toner.

Japanese Patent No. 4118498 discloses a toner for electrostatic development, where the toner includes at least a binder resin, a colorant, and a release agent, a molecular weight distribution measured by gel permeation chromatography (GPC) of a THF-soluble component of the toner (mainly the binder resin) has a main peak between 1,000 and 10,000, a half value width of the molecular weight distribution is 15,000 or less, and the toner includes a chloroform-insoluble component in an amount of from 5% through 40%. As a result, a toner that achieves low-temperature fixing where fixing of the toner can be performed at a low temperature can be provided. Moreover, a toner for forming an image having excellent hot offset resistance and heat storage stability can be provided.

According to the technology disclosed in Japanese Patent No. 4118498, however, stress resistance of the toner is not sufficient and a problem that cracking of the toner occurs when the toner is used in one-component development cannot be solved. Since the molecular weight is low and the half value width is small, moreover, a viscosity of the toner, particularly the pulverization toner, is low. Therefore, it is difficult to sufficiently apply shearing force. As a result, dispersibility of a charge controlling agent or the release agent included in the toner may be poor.

As described above, the toner known in the art may have excellent fixability (low-temperature fixability and hot offset resistance), but not sufficient stress resistance. Therefore, the toner known in the art has a problem that a problem associated with quality (e.g., blade adhesion and filming to a photoconductor) caused by cracking of the toner tends to occur.

### SUMMARY OF THE INVENTION

According to one aspect of the present disclosure, a toner is a toner including a binder resin. The toner includes a THF-insoluble component in an amount of from 10% by mass through 40% by mass. A molecular weight distribution of a THF-soluble component of the toner measured by gel permeation chromatography (GPC) has a main peak between 10,000 and 16,000, and a half value width of the main peak is a molecular weight of from 60,000 through 90,000. The THF-soluble component of the toner includes a component having a molecular weight of 2,000 or less in an amount of from 15.0% by mass through 25.0% by mass, and a component having a molecular weight of 100,000 or greater in an amount of 10.0% by mass or less as measured by GPC.

### BRIEF DESCRIPTION OF THE DRAWINGS

FIG. 1 is a schematic view illustrating one example of a molecular weight distribution of a toner;

FIG. 2 is a schematic view illustrating one example of a process cartridge according to the present disclosure;

FIG. 3 is a schematic view illustrating one example of an image forming apparatus of the present disclosure;

FIG. 4 is a schematic view illustrating another example of the image forming apparatus of the present disclosure;

FIG. 5 is a schematic view illustrating another example of the image forming apparatus of the present disclosure; and

FIG. 6 is a schematic view illustrating another example of the image forming apparatus of the present disclosure.

### DESCRIPTION OF THE EMBODIMENTS

The present disclosure has an object to provide a toner having sufficient stress resistance with excellent fixability (low-temperature fixability and hot offset resistance) and not causing cracking or adhesion to a regulation blade even when the toner is used in one-component development.

The present disclosure can provide a toner having sufficient stress resistance with excellent fixability (low-temperature fixability and hot offset resistance) and not causing cracking or adhesion to a regulation blade even when the toner is used in one-component development.

### (Toner)

A toner of the present disclosure includes at least a binder resin.

The toner includes a THF-insoluble component in an amount of from 10% by mass through 40% by mass.

A molecular weight distribution of a THF-soluble component of the toner measured by gel permeation chromatography (GPC) has a main peak between 10,000 and 16,000, and a half value width of the main peak is a molecular weight of from 60,000 through 90,000.

The THF-soluble component of the toner includes a component having a molecular weight of 2,000 or less in an amount of from 15.0% by mass through 25.0% by mass, and a component having a molecular weight of 100,000 or greater in an amount of 10.0% by mass or less as measured by GPC.

The present disclosure can provide a toner that has sufficient stress resistance with excellent fixability (low-temperature fixability and hot offset resistance) and does not cause cracking even when the toner is used in one-component development (a toner for one-component development).

Through the present disclosure, the present inventors have confirmed a novel technical idea that to define a peak molecular weight with setting a half value width of the main peak being from 60,000 through 90,000 in a molecular weight distribution of the toner is very effective for improving resistance against cracking of the toner.

As a result of researches conducted by the present inventors, it is important that a molecular weight distribution of a THF-soluble component of a resin constituting a toner as measured by GPC has a main peak between 10,000 and 16,000 and a half value width of the main peak is a molecular weight of from 60,000 through 90,000. It has been found from the above that particularly significantly excellent resistance against cracking can be realized compared to toners in the art. Based on the insight above, the present disclosure has been accomplished. The details will be described below.

### <THF-Insoluble Component>

The toner of the present disclosure includes a tetrahydrofuran (THF)-insoluble component in an amount of from 10% by mass through 40% by mass. To make an absolute amount of the THF-insoluble component of the toner smaller than an absolute amount of a THF-soluble component of the toner is important. Specifically, it is important that an amount of the THF-insoluble component in the toner is from 10% by mass through 40% by mass. By adjusting the amount of the THF-insoluble component in the above-described manner, low-temperature fixability and hot offset resistance can be improved. When the amount of the THF-insoluble component is less than 10% by mass, deterioration of fixability or cracking of the toner occurs. When the amount of the THF-insoluble component is greater than 40% by mass, low-temperature fixability is deteriorated.

The toner preferably includes the THF-insoluble component in an amount of from 16% by mass through 40% by mass, and more preferably in an amount of from 30% by mass through 40% by mass.

A method for determining a THF-insoluble component is not particularly limited. For example, the THF-insoluble component can be determined in the following manner. The toner is weighed by about 50 mg. To the toner, 10 g of THF is added. The toner is sufficiently dissolved to prepare a toner solution. The toner solution is separated by centrifugation. Then, the supernatant is dried and a solid content of the supernatant is calculated. A difference between the solid content of the toner solution initially prepared and the solid content of the supernatant is determined as a THF-insoluble component.

### <THF-Soluble Component>

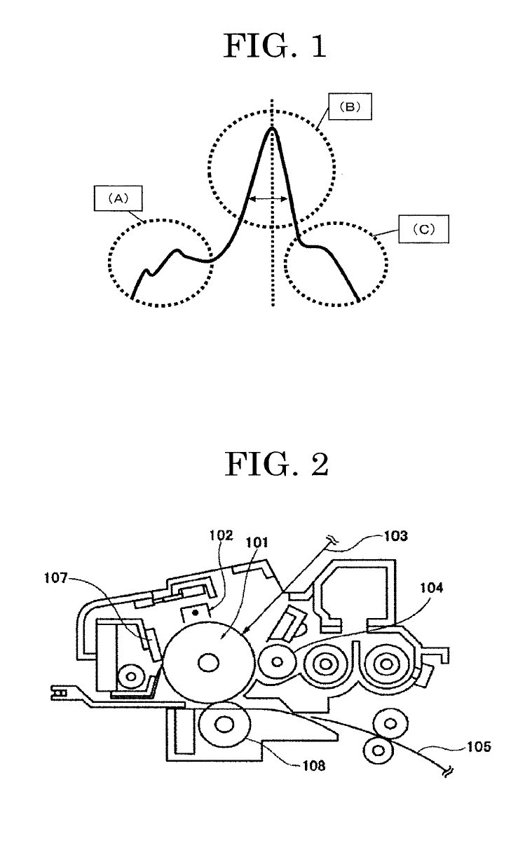

A schematic view illustrating one example of a molecular weight distribution obtained by GPC of the THF-soluble component of the toner is presented in FIG. 1. In FIG. 1, a horizontal axis is a molecular weight and a vertical axis is peak density. (A) in FIG. 1 represents a low molecular weight region and a component of the low molecular weight region secures low-temperature fixability. Moreover, (B) in FIG. 1 indicates that a main peak is present between a molecular weight of 10,000 and a molecular weight of 16,000, and toughness of the toner can be secured by controlling a molecular weight of the main peak and the half value width. (C) in FIG. 1 represents a high molecular weight region, influence to the lower limit of fixing can be suppressed by reducing a component of the high molecular weight region.

Moreover, a value of the peak of the molecular weight distribution measured by GPC and the half value width molecular weight of the distribution are important in order to secure cracking resistance. By controlling the value of the peak and the half value width molecular weight to the predetermined values, a backbone part of the molecular weight distribution necessary for obtaining resistance against cracking can be defined (see (A) of FIG. 1).

In the present disclosure, a molecular weight distribution of the THF-soluble component measured by GPC has a main peak between 10,000 and 16,000, and a half value width of the main peak is a molecular weight of from 60,000 through 90,000. In the present disclosure, the main peak means a peak having the highest intensity among the measurement result.

Cracking of the toner can be suppressed by adjusting a value of a main peak and a half value width molecular weight of the main peak in the molecular weight distribution as described above. Since sufficient shear force can be applied to the toner, especially a pulverized toner, dispersibility of a charge controlling agent, a release agent, etc. contained in the toner can be improved. When the value of the main peak is less than 10,000, cracking of the toner may occur. When the value of the main peak is greater than 16,000, low-temperature fixability may be deteriorated. When the half value width of the main peak is less than 60,000, moreover, dispersibility of wax or a charge controlling agent may be low as well as causing cracking of the toner, background fogging due to low charge or poor cracking resistance of the toner due to low dispersibility of the wax, adhesion to a regulation blade, and filming of the photoconductor may occur. When the half value width of the main peak is greater than 90,000, low-temperature fixability may be deteriorated.

As the length of the principle chain of the binder resin in the toner is longer, it is considered that toughness of the binder resin improves more. This is because the toughness of the resin improves as the length of the principle chain of the resin is longer. The toughness of the resin is improved by setting the value of the main peak to the predetermined range, and cracking of the toner can be suppressed. Moreover, dispersion of the molecular weight distribution indicates the presence of a low molecular weight component. By adjusting the half value width to the predetermined range, generation of a low molecular weight component leading to toughness of the resin can be suppressed.

In the present disclosure, moreover, a value of the main peak in the molecular weight distribution is preferably from 12,000 through 15,000, and a half value width of the main peak is preferably a molecular weight of from 65,000 through 80,000.

Furthermore, it is important in the present disclosure that a ratio of a low molecular weight region and a ratio of a high molecular weight region as measured by GPC are controlled in order to secure low-temperature fixability ((B) and (C) in FIG. 1). Specifically, in the present disclosure, it is important that the THF-soluble component of the toner includes a component having a molecular weight of 2,000 or less in an amount of from 15.0% by mass through 25.0% by mass, and a component having a molecular weight of 100,000 or greater in an amount of 10.0% by mass or less as measured by GPC. By satisfying the parameters above, excellent low-temperature fixability can be realized.

This is because mainly the low molecular weight component of the resin contributes to the lower limit of fixing. In addition, fixability can be secured without impairing stress resistance by adjusting the gel fraction (THF-insoluble component) for securing hot offset resistance to the predetermined amount to thereby secure the fixability.

When the component having a molecular weight of 2,000 or less is less than 15.0% by mass, low-temperature fixability becomes insufficient. When the component having a molecular weight of 2,000 or less is greater than 25.0% by mass, hot offset resistance is insufficient, cracking resistance of the toner is deteriorated, and adhesion to a regulation blade occurs. When the component having a molecular weight of 100,000 or greater is greater than 10.0% by mass, low-temperature fixability becomes insufficient.

The component having a molecular weight of 2,000 or less is preferably included in an amount of from 15.5% by mass through 21.0% by mass, and more preferably in an amount of from 16.5% by mass through 19.0% by mass.

The component having a molecular weight of 100,000 or greater is preferably included in an amount of 9.5% by mass or less, and more preferably in an amount of 9.0% by mass or less. The lower limit is not particularly limited and may be appropriately selected depending on the intended purpose. The component having a molecular weight of 100,000 or greater is preferably included in an amount of 3.0% by mass or greater, more preferably in an amount of 4.0% by mass or greater, and even more preferably in an amount of 5.0% by mass or greater.

For example, a GPC measurement can be performed in the following manner.
Device: GPC-150C (available from Waters)
Columns: KF801 to 807 (available from Showdex)
Temperature: 40° C.
Solvent: tetrahydrofuran (THF)
Flow rate: 1.0 mL/min
Sample: A sample having a concentration of from 0.05% through 0.6% was injected by 0.1 mL.

A number average molecular weight and weight average molecular weight of the resin are calculated from a molecular weight distribution measured under the conditions above using a molecular weight calibration curve produced with monodisperse polystyrene standard samples.

As the standard polystyrene samples for forming a calibration curve, for example, Showdex STANDARD Std. Nos. S-7300, S-210, S-390, S-875, S-1980, S-10.9, S-629, S-3.0, and S-0.580, available from SHOWA DENKO K.K., and toluene are used. As a detector, a refractive index (RI) is used.

### <Toner Component>

For example, the toner of the present disclosure includes toner base particles including at least a binder resin, where the toner base particles may further include other components according to necessity and moreover external additives are added to the toner base particles according to the necessity.

### <<Binder Resin>>

Examples of the binder resin for use in the present disclosure include polyester resins. The polyester resins are polyester resins typically obtained through polycondensation between alcohol and carboxylic acid.

Examples of the alcohol include: glycols, such as ethylene glycol, diethylene glycol, triethylene glycol, and propylene glycol; 1,4-bis(hydroxymethyl)cyclohexane; etherified bisphenol, such as bisphenol A; other divalent alcohol monomers; and trivalent or higher multivalent alcohol monomers.

Moreover, examples of carboxylic acid include: divalent organic acid monomers, such as maleic acid, fumaric acid, phthalic acid, isophthalic acid, terephthalic acid, succinic acid, and malonic acid; and trivalent or higher multivalent carboxylic acid monomers, such as 1,2,4-benzenetricarboxylic acid, 1,2,5-benzenetricarboxylic acid, 1,2,4-cyclohexanetricarboxylic acid, 1,2,4-naphthalenetricarboxylic acid, 1,2,5-hexanetricarboxylic acid, 1,3-dicarboxyl-2-methylenecarboxypropane, and 1,2,7,8-octanetetracarboxylic acid.

In view of heat storage stability, the polyester resin is preferably a polyester resin having a glass transition temperature Tg of 55° C. or higher, more preferably 60° C. or higher.

As described above, use of the polyester resin as a resin component in the toner is the most suitable. However, other resins may be used in combination as long as such resins do not impair characteristics of the toner. Examples of the usable resins other than the polyester resin include resins listed below.

Styrene-based resins (homopolymers or copolymers including styrene or substituted styrene), such as polystyrene, chloropolystyrene, poly-α-methylstyrene, styrene/chlorostyrene copolymers, styrene/propylene copolymers, styrene/butadiene copolymers, styrene/vinyl chloride copolymers, styrene/vinyl acetate copolymers, styrene/maleic acid copolymers, styrene/acrylic acid ester copolymers (e.g., styrene/methyl acrylate copolymers, styrene/ethyl acrylate copolymers, styrene/butyl acrylate copolymers, styrene/octyl acrylate copolymers, and styrene/phenyl acrylate copolymers), styrene/methacrylic acid ester copolymers (e.g., styrene/methyl methacrylate copolymers, styrene/ethyl methacrylate copolymers, styrene/butyl methacrylate copolymers, and styrene/phenyl methacrylate copolymers), styrene/methyl α-chloroacrylate copolymers, and styrene/acrylonitrile/acrylic ester copolymers; vinyl chloride resins; styrene/vinyl acetate copolymers; rosin-modified maleic acid resins; phenol resins; epoxy resins; polyethylene resins; polypropylene resins; ionomer resins; polyurethane resins; silicone resins; ketone resins; ethylene/ethyl acrylate copolymers; xylene resins; polyvinyl butyral resins; petroleum resins; and hydrogenated petroleum resins.

Production methods of the above-listed resins are not particularly limited. Any of bulk polymerization, solution polymerization, emulsion polymerization, and suspension polymerization can be used.

Moreover, a glass transition temperature Tg of each of the above-listed resins is preferably 55° C. or higher and more preferably 60° C. or higher in view of heat storage stability, similarly to the polyester resin.

### <<Release Agent>>

In the present disclosure, any of release agents known to be used in a toner in the art can be used as a release agent. As the release agent, particularly, free fatty acid carnauba wax, montan wax, and oxidized rice wax can be used alone or in combination.

As the carnauba wax, microcrystalline carnauba wax is desired, and carnauba wax having an acid value of 5 or less and having particle diameters of 1 μm or less when dispersed in a toner binder is preferable.

The montan wax is montan-based wax generally refined from minerals. Similarly to the carnauba wax, the montan wax is preferably montan wax that is microcrystalline and has an acid value of from 5 through 14.

The oxidized rice wax is rice bran wax that is oxidized through air oxidization and an acid value thereof is preferably from 10 through 30.

As other release agents, any release agents known in the art, such as solid silicone varnish, higher fatty acid higher alcohol, montan ester wax, and low molecular weight polypropylene wax, can be used in combination.

In differential scanning calorimetry (DSC) of the toner, an endothermic onset temperature of the release agent for second heating is preferably 50° C. or higher but 75° C. or lower, and more preferably 55° C. or higher but 70° C. or lower. When the endothermic onset temperature is lower than 50° C., adhesion to a regulation blade occurs. When the endothermic onset temperature is greater than 75° C., hot offset resistance is insufficient. When a range of the endothermic onset temperature of the release agent is 50° C. or higher but 75° C. or lower, the amount of the THF-insoluble component of the toner is preferably from 16% by mass through 20% by mass.

For a measurement of a melting point of the release agent (wax), a differential scanning calorimeter (DSC-6220R, available from Seiko Instruments Inc.) is used. First, a sample is heated from room temperature to 150° C. at heating speed of 10° C./min, followed by leaving for 10 minutes at 150° C. Thereafter, the sample is cooled to room temperature and left for 10 min. The sample is again heated to 150° C. at heating speed of 10° C./min. During this process, a cross point between the base line and a tangent of an inflection point is taken and the cross point is determined as an endothermic onset temperature.

An amount of the release agent is not particularly limited and may be appropriately selected depending on the intended purpose. The amount of the release agent is preferably from 1 part by mass through 20 parts by mass, more preferably from 1 part by mass through 10 parts by mass, and even more preferably from 1 part by mass through 6 parts by mass, relative to 100 parts by mass of the binder resin(s) in the toner.

### <<Colorant>>

As a colorant for use in the toner of the present disclosure, for example, any dyes and pigments known in the art, such as carbon black, lamp black, iron black, aniline blue, phthalocyanine blue, phthalocyanine green, Hanza Yellow G, Rhodamine 6C Lake, calco oil blue, chrome yellow, quinacridone, benzidine yellow, rose bengal, and a triallylmethane-based dye, may be used alone or in combination. The toner may be used as a black toner or full-color toner.

An amount of the colorant is not particularly limited and may be appropriately selected depending on the intended purpose. The amount of the colorant is preferably from 1 part by mass through 30 parts by mass and more preferably from 3 parts by mass through 20 parts by mass relative to 100 parts by mass of the binder resin(s) in the toner.

### <<Charge Controlling Agent>>

As a charge controlling agent, any charge controlling agents, such as a nigrosine dye, a metal complex salt dye, and a quaternary ammonium salt, may be used alone or in combination.

As the charge controlling agent, moreover, a complex including a trivalent or higher metal that may have a 6-coordinate structure may be used. Examples of the trivalent or higher metal include Al, Fe, Cr, and Zr. Among the above-listed examples, a complex that does not have toxicity and uses Fe as a central metal is more preferable. Among the above-listed examples, an azo iron compound is preferably used because stress resistance of the toner can be improved.

Among the above-listed examples, two or more may be mixed for use.

Examples of the azo iron compound include compounds represented by Structural Formula (1) and Structural Formula (2) below.

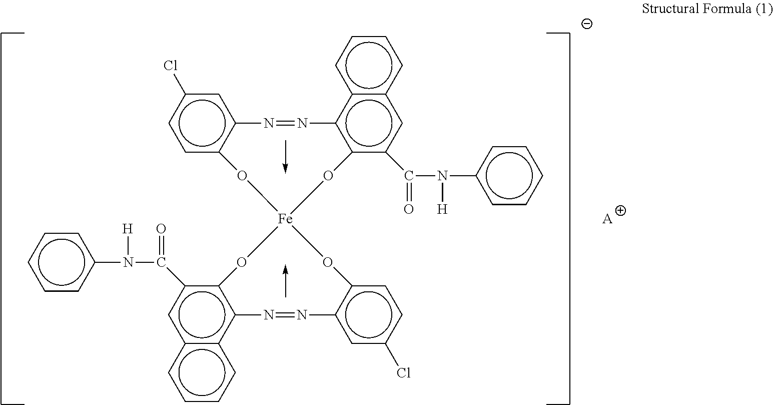

In Structural Formula (1), A⁺ is an ammonium ion.

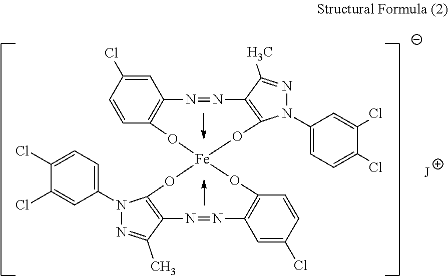

In Structural Formula (2), J⁺ is H⁺, an alkali metal cation, an ammonium ion, or an alkyl ammonium ion.

Among the above-listed examples, two or more may be mixed for use.

Among the above-listed examples, the compound represented by Structural Formula (1) having appropriate chargability and a high effect of improving background smear is preferably used.

A commercial product of the compound represented by Structural Formula (1) is not particularly limited Examples thereof include T-77 available from Hodogaya Chemical Co., Ltd.

A commercial product of the compound represented by Structural Formula (2) is not particularly limited. Examples thereof include T-159 available from Hodogaya Chemical Co., Ltd.

An amount of the azo iron compound is preferably from 0.5 parts by mass through 3.0 parts by mass relative to 100 parts by mass of the binder resin(s) in the toner.

An amount of the charge controlling agent is not particularly limited and may be appropriately selected depending on the intended purpose. The amount of the charge controlling agent is preferably from 0.1 parts by mass through 5 parts by mass and more preferably from 1 part by mass through 3 parts by mass, relative to 100 parts by mass of the binder resin(s) in the toner.

### <<Others>>

A flowability-improving agent etc. may be formulated in the toner of the present disclosure, according to the necessity.

As the flowability-improving agent, any flowability-improving agents know in the art, such as silicon oxide, titanium oxide, silicon carbide, aluminium oxide, and barium titanate, may be used alone or in combination.

An amount of the flowability-improving agent is not particularly limited and may be appropriately selected depending on the intended purpose. The amount of the flowability-improving agent is preferably from 0.1 parts by mass through 5 parts by mass, and more preferably from 0.5 parts by mass through 2 parts by mass, relative to 100 parts by mass of the toner.

### (Toner Stored Unit)

A toner stored unit of the present disclosure is a unit that has a function of storing a toner and stores the toner. Examples of embodiments of the toner stored unit include a toner stored container, a developing device, and a process cartridge.

The toner stored container is a container in which a toner is stored.

The developing device is a device including a unit configured to store a toner and develop.

The process cartridge is a process cartridge which includes at least an image bearer and a developing unit that are integrated, stores a toner, and is detachably mounted in an image forming apparatus. The process cartridge may further includes at least one selected from the group consisting of a charging unit, an exposing unit, and a cleaning unit.

Next, one embodiment of the process cartridge is illustrated in FIG. 2. As illustrated in FIG. 2, the process cartridge of the present embodiment includes a latent image bearer 101 built-in, includes a charging device 102, a developing device 104, and a cleaning unit 107, and may further include other units according to the necessity. In FIG. 2, the reference numeral 103 represents exposure light from the exposing device and the reference numeral 105 represents recording paper.

As the latent image bearer 101, a latent image bearer similar to an electrostatic latent image bearer in a below-described image forming apparatus can be used. Moreover, any charging member can be used as the charging device 102.

In an image forming process performed by the process cartridge illustrated in FIG. 2, the latent image bearer 101 is charged by the charging device 102 and exposed to exposure light 103 applied from an exposure unit (not illustrated) with rotating in the direction indicated with the arrow, to thereby form an electrostatic latent image corresponding to an exposure image on a surface of the latent image bearer.

The electrostatic latent image is developed with the toner by the developing device 104, the toner development is transferred onto the recording paper 105 by the transfer roller 108, and then the image is printed out. Subsequently, the surface of the latent image bearer after the image transfer is cleaned by the cleaning unit 107, and the charge thereof is eliminated by a charge-eliminating unit (not illustrated). Then, the series of the operations above are again repeated.

Image formation is performed using the toner of the present disclosure when the image formation is performed by mounting the toner stored unit of the present disclosure in the image forming apparatus. Therefore, the toner stored unit including the toner having sufficient stress resistance with excellent fixability (low-temperature fixability and hot offset resistance) and does not cause cracking or adhesion to a regulation blade even when the toner is used in one-component development can be obtained.

### (Image Forming Method and Image Forming Apparatus)

An image forming apparatus of the present disclosure includes at least an electrostatic latent image bearer (may be referred to as a “photoconductor” hereinafter), an electrostatic latent image forming unit, and a developing unit. The image forming apparatus may further include other units, such as a charge-eliminating unit, a cleaning unit, a recycling unit, and a controlling unit, according to the necessity.

An image forming method associated with the present disclosure includes at least an electrostatic latent image forming step and a developing step. The image forming method may further include other steps, such as a charge-eliminating step, a cleaning step, a recycling step, and a controlling step.

The image forming method can be suitably performed by the image forming apparatus. The electrostatic latent image forming step can be suitably performed by the electrostatic latent image forming unit.

The developing step can be suitably performed by the developing unit. The above-mentioned other steps can be suitably performed by the above-mentioned other units.

### —Electrostatic Latent Image Forming Step and Electrostatic Latent Image Forming Unit—

The electrostatic latent image forming step is a step including forming an electrostatic latent image on an electrostatic latent image bearer.

A material, shape, structure, size, etc., of the electrostatic latent image bearer (may be referred to as an “electrophotographic photoconductor” or a “photoconductor”) are not particularly limited and may be appropriately selected from electrostatic latent image bearers known in the art. The shape thereof is dubitably a drum shape. Examples of the material thereof include; inorganic photoconductors, such as amorphous silicon and selenium; and organic photoconductors (OPC), such as polysilane and phthalopolymethine. Among the above-listed example, the organic photoconductor (OPC) is preferable because an image of higher resolution can be obtained.

For example, formation of the electrostatic latent image can be performed by uniformly charging a surface of the electrostatic latent image bearer, followed by exposing the surface to light imagewise, and can be performed by the electrostatic latent image forming unit.

For example, the electrostatic latent image forming unit includes at least a charging unit (a charger) configured to uniformly charge a surface of the electrostatic latent image bearer and an exposing unit (an exposure) configured to expose the surface of the electrostatic latent image bearer imagewise.

For example, the charging can be performed by applying voltage to a surface of the electrostatic latent image bearer using the charger.

The charger is not particularly limited and may be appropriately selected depending on the intended purpose. Examples of the charger include contact chargers, known in the art themselves, each equipped with a conductive or semiconductive roller, brush, film, or rubber blade, and non-contact chargers utilizing corona discharge, such as corotron, and scorotron.

The charger is preferably a charger that is disposed in contact with or without contact with the electrostatic latent image bearer and is configured to apply superimposed DC and AC voltage to charge a surface of the electrostatic latent image bearer.

Moreover, the charger is preferably a charger that is disposed close to the electrostatic latent image bearer via a gap tape without contacting with the electrostatic latent image bearer, and is configured to apply superimposed DC and AC voltage to the charging roller to charge a surface of the electrostatic latent image bearer.

For example, the exposure can be performed by exposing the surface of the electrostatic latent image bearer to light imagewise using the exposure.

The exposing unit is not particularly limited and may be appropriately selected depending on the intended purpose, as long as the exposure is capable of exposing the charged surface of the electrostatic latent image bearer to light in the shape of an image to be formed. Examples of the exposure include various exposing units, such as copy optical exposing units, rod lens array exposing units, laser optical exposing units, and liquid crystal shutter optical exposing units.

Note that, in the present disclosure, a back-exposure system may be employed. The back-exposure system is a system where imagewise exposure is performed from the back side of the electrostatic latent image bearer.

### —Developing Step and Developing Unit—

The developing step is a step including developing the electrostatic latent image with the toner to form a visible image.

For example, formation of the visible image can be performed by developing the electrostatic latent image with the toner and can be performed by the developing unit.

For example, the developing unit is preferably a developing unit that stores the toner therein and includes at least a developing device capable of applying the toner to the electrostatic latent image directly or indirectly. The developing unit is more preferably a developing device etc. equipped with a toner stored container.

The developing device may be a developing device for a single color or a developing device for multiple colors. For example, the developing device is preferably a developing device including a stirrer configured to stir the toner to cause friction to thereby charge the toner, and a rotatable magnet roller.

Inside the developing device, for example, the toner and the carrier are mixed and stirred to cause frictions, the toner is charged by the frictions, and the charged toner is held on a surface of the rotating magnetic roller in the form of a brush to thereby form a magnetic brush. Since the magnetic roller is disposed adjacent to the electrostatic latent image bearer (photoconductor), part of the toner constituting the magnetic brush formed on the surface of the magnetic roller is transferred onto a surface of electrostatic latent image bearer (photoconductor) by electric suction force. As a result, the electrostatic latent image is developed with the toner to form a visible image formed of the toner on the surface of the electrostatic latent image bearer (photoconductor).

### —Transferring Step and Transferring Unit—

The transferring step is a step including transferring the visible image to a recording medium. A preferable embodiment of the transferring step is an embodiment where an intermediate transfer member is used, the visible image is primary transferred onto the intermediate transfer member and then the visible image is secondary transferred onto the recording medium. A more preferable embodiment thereof is an embodiment using two or more colors of the toners, preferably full-color toners, and including a primary transfer step and a secondary transfer step, where the primary transfer step includes transferring visible images on the intermediate transfer member to form a composite transfer image, and the secondary transfer step includes transferring the composite transfer image onto the recording medium.

For example, the transfer can be performed by charging the visible image on the electrostatic latent image bearer (photoconductor) using a transfer charger. The transfer can be performed by the transferring unit. A preferable embodiment of the transferring unit is a transferring unit including a primary transferring unit configured to transfer visible images onto an intermediate transfer member to form a composite transfer image, and a secondary transferring unit configured to transfer the composite transfer image onto a recording medium.

Note that, the intermediate transfer member is not particularly limited and may be appropriately selected from transfer members known in the art depending on the intended purpose. Preferable examples of the intermediate transfer member include a transfer belt.

The transferring unit (the primary transferring unit and the secondary transferring unit) preferably includes at least a transferring unit configured to charge and release the visible image formed on the electrostatic latent image bearer (photoconductor) to the side of the recording medium. The number of the transferring unit may be one, or two or more.

Examples of the transferring unit include a corona transferring unit using corona discharge, a transfer belt, a transfer roller, a pressure transfer roller, and adhesion transferring unit.

Note that, the recording medium is not particularly limited and may be appropriately selected from recording media (recording paper) known in the art.

### —Fixing Step and Fixing Unit—

The fixing step is a step including fixing the visible image transferred to the recording medium using the fixing device. The fixing step may be performed every time a visible image of each color of the developer is transferred. Alternatively, the fixing step may be performed once at the same time in a state visible images of all the colors of the developers are laminated.

The fixing device is not particularly limited and may be appropriately selected depending on the intended purpose. The fixing device is suitably any of heat pressure units known in the art. Examples of the heat pressure units include a combination of a heat roller and a pressure roller and a combination of a heat roller, a pressure roller, and an endless belt.

The fixing device is preferably a unit that includes a heating body equipped with a heat generator, a film in contact with the heating body, and a press member pressed against the heating body via the film, and is configured to pass a recording medium, on which an unfixed image is formed, between the film and the press member to heat-fixing the image onto the recording medium. Heating performed by the heat-press unit is generally preferably performed at a temperature of from 80° C. through 200° C.

In the present disclosure, in combination with or instead of the fixing step and the fixing unit, for example, a photofixing device known in the art may be used depending on the intended purpose.

The charge-eliminating step is a step including applying charge elimination bias to the electrostatic latent image bearer to eliminate the charge. The charge-eliminating step can be suitably performed by the charge-eliminating unit.

The charge-eliminating unit is not particularly limited as long as the charge-eliminating unit is capable of applying charge-eliminating bias to the electrostatic latent image bearer, and may be appropriately selected from charge eliminators known in the art. For example, the charge-eliminating unit is preferably a charge-eliminating lamp etc.

The cleaning step is a step including removing the toner remained on the electrostatic latent image bearer. The cleaning step can be suitably performed by the cleaning unit.

The cleaning unit is not particularly limited as long as the cleaning unit is capable of removing the toner remained on the electrostatic latent image bearer, and may be appropriately selected from cleaners known in the art. Examples of the cleaning unit include a magnetic brush cleaner, an electrostatic brush cleaner, a magnetic roller cleaner, a blade cleaner, a brush cleaner, and a web cleaner.

The recycling step is a step including recycling the toner removed by the cleaning step to the developing unit. The recycling step can be suitably performed by the recycling unit. The recycling unit is not particularly limited and may be any of conveying units known in the art.

The controlling step is a step including controlling each of the above-mentioned steps. The controlling step can be suitably performed by the controlling unit.

The controlling unit is not particularly limited and may be appropriately selected depending on the intended purpose, as long as the controlling unit is capable of controlling operation of each of the above-mentioned units. Examples of the controlling unit include devices, such as a sequencer and a computer.

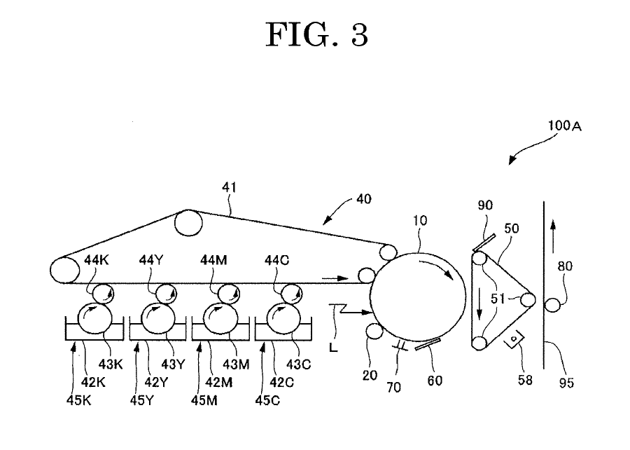

A first example of the image forming apparatus of the present disclosure is illustrated in FIG. 3. The image forming apparatus 100A includes a photoconductor drum 10, a charging roller 20, an exposing device, a developing device 40, an intermediate transfer belt 50, a cleaning device 60 including a cleaning blade, and a charge-eliminating lamp 70.

The intermediate transfer belt 50 is an endless belt supported by 3 rollers 51 disposed inside the intermediate transfer belt 50 and can move in the direction indicated with the arrow in FIG. 3. Part of the 3 rollers 51 also functions as a transfer bias roller capable of applying transfer bias (primary transfer bias) to the intermediate transfer belt 50. Moreover, the cleaning device 90 including the cleaning blade is disposed adjacent to the intermediate transfer belt 50. Furthermore, the transfer roller 80 capable of applying transfer bias (secondary bias) to the transfer paper 95 to transfer the toner image is disposed to face the intermediate transfer belt 50.

At the periphery of the intermediate transfer belt 50, moreover, the corona charger 58 configured to apply charge to the toner image transferred to the intermediate transfer belt 50 is disposed between a contact area between the photoconductor drum 10 and the intermediate transfer belt 50 and a contact area between the intermediate transfer belt 50 and the transfer paper 95 along the rotational direction of the intermediate transfer belt 50.

The developing device 40 is composed of a developing belt 41, and a black developing unit 45K, a yellow developing unit 45Y, a magenta developing unit 45M, and a cyan developing unit 45C disposed together at the periphery of the developing belt 41. Note that, the developing unit 45 of each color includes a developer stored unit 42, a developer supply roller 43, and a developing roller (developer bearer) 44. Moreover, the developing belt 41 is an endless belt supported by a plurality of belt rollers, and can move in the direction indicated with the arrow in FIG. 3. Furthermore, part of the developing belt 41 is in contact with the photoconductor drum 10.

Next, a method for forming an image using the image forming apparatus 100A will be described. First, a surface of the photoconductor drum 10 is uniformly charged by the charging roller 20. Then, the photoconductor drum 10 is exposed to exposure light L by means of an exposing device (not illustrated) to form an electrostatic latent image. Next, the electrostatic latent image formed on the photoconductor drum 10 is developed with a toner supplied from the developing device 40, to thereby form a toner image. Moreover, the toner image formed on the photoconductor drum 10 is transferred (primary transferred) onto the intermediate transfer belt 50 by the transfer bias applied from the roller 51. Then, the toner image is transferred (secondary transferred) onto transfer paper 95 by the transfer bias applied from the transfer roller 80. Meanwhile, the toner remained on the surface of the photoconductor drum 10, from which the toner image has been transferred to the intermediate transfer belt 50, is removed by the cleaning device 60. Then, the charge of the photoconductor drum is eliminated by the charge-eliminating lamp 70.

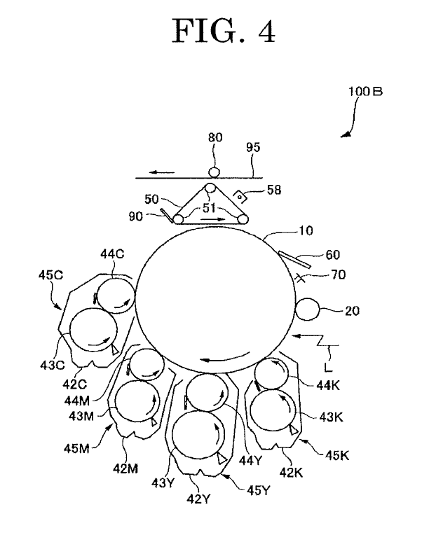

A second example of the image forming apparatus for use in the present disclosure is illustrated in FIG. 4. The image forming apparatus 100B has the identical structure to the structure of the image forming apparatus 100A, except that a black developing unit 45K, a yellow developing unit 45Y, a magenta developing unit 45M, and a cyan developing unit 45C are disposed at the periphery of the photoconductor drum 10 to directly face the photoconductor drum 10 without disposing the developing belt 41.

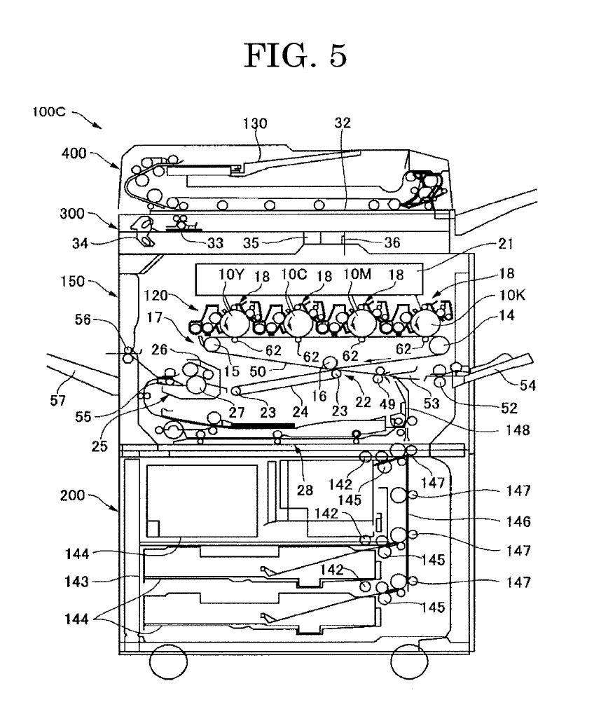

A third example of an image forming apparatus for use in the present disclosure is illustrated in FIG. 5. The image forming apparatus 100C is a tandem color image forming apparatus and includes a copier main body 150, a paper feeding table 200, a scanner 300, and an automatic document feeder (ADF) 400.

An intermediate transfer belt 50 disposed at a center of the copier main body 150 is an endless belt supported by three rollers 14, 15, and 16, and can move in the direction indicated with the arrow in FIG. 5. Near the roller 15, disposed is a cleaning device 17 having a cleaning blade configured to remove the toner remained on the intermediate transfer belt 50 from which the toner image has been transferred to recording paper. Yellow, cyan, magenta, and black image forming units 120Y, 120C, 120M, and 120K are aligned and disposed along the conveying direction to face a section of the intermediate transfer belt 50 supported by the rollers 14 and 15.

Moreover, an exposing device 21 is disposed near the image forming unit 120. Moreover, a secondary transfer belt 24 is disposed at the side of the intermediate transfer belt 50 opposite to the side thereof where the image forming unit 120 is disposed. Note that, the secondary transfer belt 24 is an endless belt supported by a pair of rollers 23. Recording paper transported on the secondary transfer belt 24 and the intermediate transfer belt 50 can be in contact with each other at the section between the roller 16 and the roller 23.

Moreover, a fixing device 25 is disposed near the secondary transfer belt 24, where the fixing device includes a fixing belt 26 that is an endless belt supported by a pair of rollers, and a pressure roller 27 disposed to press against the fixing belt 26. Note that, a sheet reverser 28 configured to reverse recording paper when images are formed on both sides of the recording paper is disposed near the secondary transfer belt 24 and the fixing device 25.

Next, a method for forming a full-color image using the image forming apparatus 100C will be explained. First, a color document is set on a document table 130 of the automatic document feeder (ADF) 400. Alternatively, the automatic document feeder 400 is opened, a color document is set on contact glass 32 of the scanner 300, and then automatic document feeder 400 is closed. In the case where the document is set on the automatic document feeder 400, once a start switch is pressed, the document is transported onto the contact glass 32, and then the scanner 300 is driven to scan the document with a first carriage 33 equipped with a light source and a second carriage 34 equipped with a mirror. In the case where the document is set on the contact glass 32, the scanner 300 is immediately driven to scan the document with the first carriage 33 and the second carriage 34. During the scanning operation, light emitted from the first carriage 33 is reflected by the surface of the document, the reflected light from the surface of the document is reflected by the second carriage 34, and then the reflected light is received by a reading sensor 36 via an image formation lens 35 to read the document, to thereby image information of black, yellow, magenta, and cyan.

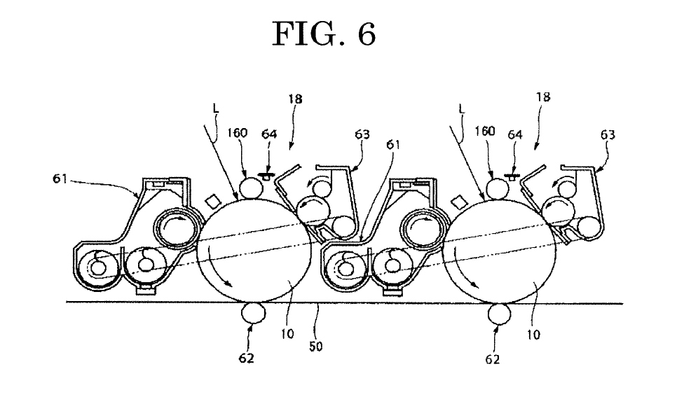

The image information of each color is transmitted to each image forming device 18 of each image-forming unit 120 of each color to form a toner image of each color. As illustrated in FIG. 6, the image-forming unit 120 of each color includes a photoconductor drum 10, a charging roller 160 configured to uniformly charge the photoconductor drum 10, an exposing device configured to expose the photoconductor drum 10 to exposure light L based on the image information of each color to form an electrostatic latent image for each color, a developing device 61 configured to develop the electrostatic latent image with a developer of each color to form a toner image of each color, a transfer roller 62 configured to transfer the toner image onto an intermediate transfer belt 50, a cleaning device 63 including a cleaning blade, and a charge-eliminating lamp 64.

The toner images of all of the colors formed by the image forming units 120 of all of the colors are sequentially transferred (primary transferred) onto the intermediate transfer belt 50 rotatably supported by the rollers 14, 15, and 16 to superimpose the toner images to thereby form a composite toner image.

In the paper feeding table 200, meanwhile, one of the paper feeding rollers 142 is selectively rotated to eject recording paper from one of multiple paper feeding cassettes 144 of the paper bank 143, pieces of the ejected recording paper are separated one by one by a separation roller 145 to send each recording paper to a paper feeding path 146, and then transported by a conveying roller 147 into a paper feeding path 148 within the copier main body 150. The recording paper transported in the paper feeding path 148 is then bumped against a registration roller 49 to stop. Alternatively, pieces of the recording paper on a manual-feeding tray 54 are ejected by rotating a paper feeding roller, separated one by one by a separation roller 52 to guide into a manual paper feeding path 53, and then bumped against the registration roller 49 to stop.

Note that, the registration roller 49 is generally earthed at the time of use, but it may be biased for removing paper dusts of the recording paper. Next, the registration roller 49 is rotated synchronously with the movement of the composite toner image on the intermediate transfer belt 50, to thereby send the recording paper between the intermediate transfer belt 50 and the secondary transfer belt 24. The composite toner image is then transferred (secondary transferred) to the recording paper. Note that, the toner remained on the intermediate transfer belt 50, from which the composite toner image has been transferred, is removed by the cleaning device 17.

The recording paper to which the composite toner image has been transferred is transported on the secondary transfer belt 24 and then the composite toner image is fixed thereon by the fixing device 25. Next, the traveling path of the recording paper is switched by a separation craw 55 and the recording paper is ejected to a paper ejection tray 57 by an ejecting roller 56. Alternatively, the traveling path of the recording paper is switched by the separation craw 55, the recording paper is reversed by the sheet reverser 28, an image is formed on a back side of the recording paper in the same manner, and then the recording paper is ejected to the paper ejection tray 57 by the ejecting roller 56.

### EXAMPLES

Examples of the present disclosure will be described below. However, the present disclosure should not be construed as being limited to the Examples. “Part(s)” denotes “part(s) by mass” and “%” denotes “% by mass” unless otherwise stated.

### Production Example 1

### <Production of Polyester Resins A-1 to A-6 and Polyester Resins B-1 to B-8>

A 4-necked round-bottom flask having a volume of 1 L and equipped with a thermometer, a stirrer, a condenser, and a nitrogen inlet tube was charged with each of the compositions presented in Table 1 and Table 2. The flask was then set in a heating mantle, and then was heated in a state that the internal atmosphere of the flask was maintained as inert atmosphere by introducing nitrogen gas through the nitrogen inlet tube. Subsequently, 0.05 parts by mass of dibutyl tin oxide was added and the resultant mixture was allowed to react with maintaining the temperature at 200° C., to thereby obtain each of polyester resins presented in Table 1 and Table 2.

### <Measurements of Physical Properties>

The following measurements were performed on each of the obtained polyesters.

### —Molecular Weight Measurement (GPC)—

Gel permeation chromatography (GPC) was performed under the following conditions.
Device: GPC-150C (available from Waters)
Columns: KF801 to 807 (available from Showdex)
Temperature: 40° C.
Solvent: tetrahydrofuran (THF)
Flow rate: 1.0 mL/min
Sample: A sample having a concentration of from 0.05% through 0.6% was injected by 0.1 mL.

A number average molecular weight and weight average molecular weight of the resin were calculated from a molecular weight distribution measured under the conditions above using a molecular weight calibration curve produced with monodisperse polystyrene standard samples.

As the standard polystyrene samples for forming a calibration curve, for example, Showdex STANDARD Std. Nos. S-7300, S-210, S-390, S-875, S-1980, S-10.9, S-629, S-3.0, and S-0.580, available from SHOWA DENKO K.K., and toluene were used. As a detector, a refractive index (RI) was used.

### —THF-Insoluble Component—

The binder resin was weighed by about 50 mg. To the binder resin, 10 g of THF was added. The binder resin was sufficiently dissolved to prepare a resin solution. The resin solution was separated by centrifugation. Then, the supernatant was dried and a solid content of the supernatant was calculated. A difference between the solid content of the resin solution initially prepared and the solid content of the supernatant was determined as a THF-insoluble component.

The formulation and physical properties of each polyester resin are presented in Table 1 and Table 2. Note that, in Tables 1 and 2, the values for the acid component and the alcohol components are represented by “part(s) by mass,” “Mw” represents a weight average molecular weight, and the value of THF-insoluble component is represented by “%.” Moreover, the value for “peak top molecular weight” represents a molecular weight of a main peak value.

TABLE 1

| | | Polyester Resin A | | | | | |
|---|---|---|---|---|---|---|---|
| | | Resin | Resin | Resin | Resin | Resin | Resin |
| | | A-1 | A-2 | A-3 | A-4 | A-5 | A-6 |
| Acid | Terephthalic acid | 25 | 35 | 15 | 40 | 15 | 20 |
| component | Fumaric acid | 30 | 10 | 20 | | 20 | 20 |
| | Succinic acid | | 5 | 15 | 10 | 15 | 10 |
| | Trimellitic acid | | | | | | |
| Alcohol | Bisphenol A (2.2) | 25 | 15 | 35 | 45 | 40 | 35 |
| component | propylene oxide | | | | | | |
| | Bisphenol A (2.2) | 20 | 35 | 15 | 5 | 10 | 15 |
| | ethylene oxide | | | | | | |
| Physical | Mw | 36,000 | 32,000 | 42,500 | 60,000 | 40,000 | 45,000 |
| properties | Peak top | 13,000 | 9,000 | 11,000 | 11,000 | 10,800 | 10,800 |
| | molecular weight | | | | | | |
| | THF-insoluble | 0 | 0 | 0 | 0 | 0 | 0 |
| | component | | | | | | |

TABLE 2

| | | Polyester Resin B | | | | | | | |
|---|---|---|---|---|---|---|---|---|---|
| | | Resin | Resin | Resin | Resin | Resin | Resin | Resin | Resin |
| | | B-1 | B-2 | B-3 | B-4 | B-5 | B-6 | B-7 | B-8 |
| Acid | Terephthalic | 20 | 20 | 15 | 10 | 10 | 22.5 | 15 | 13 |
| component | acid | | | | | | | | |
| | Fumaric | 20 | | 15 | 30 | 15 | 22.5 | 15 | 30 |
| | acid | | | | | | | | |
| | Succinic acid | | | | | 18 | | | |
| | Trimellitic | 10 | 30 | 20 | 15 | 7 | 5 | 20 | 12 |
| | acid | | | | | | | | |
| Alcohol | Bisphenol A | 15 | 15 | 35 | 40 | 20 | 15 | 40 | 40 |
| component | (2.2) | | | | | | | | |
| | propylene | | | | | | | | |
| | oxide | | | | | | | | |
| | Bisphenol A | 35 | 35 | 15 | 10 | 30 | 35 | 10 | 10 |
| | (2.2) | | | | | | | | |
| | ethylene | | | | | | | | |
| | oxide | | | | | | | | |
| Physical | Mw | 55,000 | 40,000 | 38,000 | 80,000 | 72,000 | 60,000 | 34,000 | 90,000 |
| properties | Peak top | 12,000 | 18,000 | 13,000 | 16,200 | 9,500 | 13,000 | 12,500 | 16,500 |
| | molecular | | | | | | | | |
| | weight | | | | | | | | |
| | THF-insoluble | 19 | 38 | 27 | 25 | 13 | 10 | 26 | 22 |
| | component | | | | | | | | |

### Example 1-1

After sufficiently mixing a mixture having the following composition in Henschel Mixer, the resultant was heated and melted for about 30 minutes at a temperature of from 130° C. through 140° C. by means of a roll mill. After cooling the resultant to room temperature, the obtained kneaded product was pulverized by means of a jet mill or a mechanical pulverizer and classified by means of an air classifier to thereby obtain toner base particles.

### —Composition—

Polyester Resin A-1: 50 parts
Polyester Resin B-1: 50 parts
Rice wax (TOWAX-3F16, available from TOAKASEI CO., LTD.): 5 parts
Carbon black (#44, available from Mitsubishi Chemical Corporation): 10 parts
Metal-containing azo compound (T-77, available from Hodogaya Chemical Co., Ltd.): 1 part

To the obtained toner base particles, 0.5% by mass of hydrophobic silica was added to thereby obtain [Toner 1-1].

### Example 1-2

[Toner 1-2] was obtained in the same manner as in Example 1-1, except that [Polyester Resin B-1] was changed to [Polyester Resin B-2].

### Example 1-3

[Toner 1-3] was obtained in the same manner as in Example 1-1, except that [Polyester Resin A-1] was changed to [Polyester Resin A-2] and [Polyester Resin B-1] was changed to [Polyester Resin B-3].

### Example 1-4

[Toner 1-4] was obtained in the same manner as in Example 1-1, except that [Polyester Resin B-1] was changed to [Polyester Resin B-4].

### Example 1-5

[Toner 1-5] was obtained in the same manner as in Example 1-1, except that the types and amounts of the binder resins were changed to 60 parts by mass of [Polyester Resin A-2] and 40 parts by mass of [Polyester Resin B-3].

### Example 1-6

[Toner 1-6] was obtained in the same manner as in Example 1-1, except that [Polyester Resin A-1] was changed to [Polyester Resin A-3] and [Polyester Resin B-1] was changed to [Polyester Resin B-4].

### Example 1-7

[Toner 1-7] was obtained in the same manner as in Example 1-1, except that the types and amounts of the binder resins were changed to 40 parts by mass of [Polyester Resin A-3] and 60 parts by mass of [Polyester Resin B-4].

### Example 1-8

[Toner 1-8] was obtained in the same manner as in Example 1-1, except that the types and amounts of the binder resin were changed to 70 parts by mass of [Polyester Resin A-2] and 30 parts by mass of [Polyester Resin B-3].

### Comparative Example 1-1

[Comparative Toner 1-1] was obtained in the same manner as in Example 1-1 except that [Polyester Resin B-1] was changed to [Polyester Resin B-5].

### Comparative Example 1-2

[Comparative Toner 1-2] was obtained in the same manner as in Example 1-1 except that the types and amounts of the binder resins were changed to 35 parts by mass of [Polyester Resin A-1] and 65 parts by mass of [Polyester Resin B-2].

### Comparative Example 1-3

[Comparative Toner 1-3] was obtained in the same manner as in Example 1-1 except that [Polyester Resin B-1] was changed to [Polyester Resin B-6].

### Comparative Example 1-4

[Comparative Toner 1-4] was obtained in the same manner as in Example 1-1 except that the types and amounts of the binder resins were changed to 35 parts by mass of [Polyester Resin A-2] and 65 parts by mass of [Polyester Resin B-2].

### Comparative Example 1-5

[Comparative Toner 1-5] was obtained in the same manner as in Example 1-1 except that the types and amounts of the binder resins were changed to 60 parts by mass of [Polyester Resin A-2] and 40 parts by mass of [Polyester Resin B-3].

### Comparative Example 1-6

[Comparative Toner 1-6] was obtained in the same manner as in Example 1-1 except that the types and amounts of the binder resins were changed to 35 parts by mass of [Polyester Resin A-3] and 65 parts by mass of [Polyester Resin B-4].

### Comparative Example 1-7

[Comparative Toner 1-7] was obtained in the same manner as in Example 1-1 except that the types and amounts of the binder resins were changed to 60 parts by mass of [Polyester Resin A-2] and 40 parts by mass of [Polyester Resin B-7].

### Comparative Example 1-8

[Comparative Toner 1-8] was obtained in the same manner as in Example 1-1 except that [Polyester Resin A-1] was changed to [Polyester Resin A-5] and [Polyester Resin B-1] was changed to [Polyester Resin B-4].

### Comparative Example 1-9

[Comparative Toner 1-9] was obtained in the same manner as in Example 1-1 except that the types and amounts of the binder resins were changed to 40 parts by mass of [Polyester Resin A-6] and 60 parts by mass of [Polyester Resin B-4].

### Comparative Example 1-10

[Comparative Toner 1-10] was obtained in the same manner as in Example 1-1 except that the types and amounts of the binder resins were changed to 75 parts by mass of [Polyester Resin A-2] and 25 parts by mass of [Polyester Resin B-3].

### Comparative Example 1-11

[Comparative Toner 1-11] was obtained in the same manner as in Example 1-1 except that the types and amounts of the binder resins were changed to 40 parts by mass of [Polyester Resin A-3] and 60 parts by mass of [Polyester Resin B-8].

### (Measurements)

The following measurements were performed on each of the toners obtained above.

### <THF-Insoluble Component>

The toner was weighed by about 50 mg. To the toner, 10 g of THF was added. The toner was sufficiently dissolved to prepare a toner solution. The toner solution was separated by centrifugation. Then, the supernatant was dried and a solid content of the supernatant was calculated. A difference between the solid content of the toner solution initially prepared and the solid content of the supernatant was determined as a THF-insoluble component.

### <THF-Soluble Component>

The toner was weighed by 50 mg. To the toner, 10 g of THF was added. The toner was sufficiently dissolved to prepare a solution. The solution was separated by centrifugation. Then, the supernatant was dried and a solid content mass [X (mg)] of the supernatant was determined.

Moreover, an amount (% by mass) of the THF-soluble component of the toner was determined by Formula (1) below.

THF-soluble component (% by mass) of the toner=X/50 mg×100 Formula (1)

Note that, the solid content of the supernatant is an equivalent of the THF-soluble component.

### <<GPC Measurement>>

Gel permeation chromatography (GPC) was performed on each of the toners obtained above under the following conditions.
Device: GPC-150C (available from Waters)
Columns: KF801 to 807 (available from Showdex)
Temperature: 40° C.
Solvent: tetrahydrofuran (THF)
Flow rate: 1.0 mL/min
Sample: A sample having a concentration of from 0.05% through 0.6% was injected by 0.1 mL.

A number average molecular weight and weight average molecular weight of the resin were calculated from a molecular weight distribution measured under the conditions above using a molecular weight calibration curve produced with monodisperse polystyrene standard samples.

As the standard polystyrene samples for forming a calibration curve, for example, Showdex STANDARD Std. Nos. S-7300, S-210, S-390, S-875, S-1980, S-10.9, S-629, S-3.0, and S-0.580, available from SHOWA DENKO K.K., and toluene were used. As a detector, a refractive index (RI) was used.

A list of the physical properties of the obtained toners is presented in Table 3.

TABLE 3

| | | | | | Physical properties of toner | | | | |
|---|---|---|---|---|---|---|---|---|---|
| | | | | | | THF-soluble component | | | |
| | | | | | | | | Amount of | Amount of |
| | | | | | THF- | | | component | component |
| | | | | | insoluble | Peak top | Half | of 2,000 or | of 100,000 |
| | Resin type | | | | component | molecular | value | less | or greater |
| | Resin A | | Resin B | | (mass %) | weight | width | (mass %) | (mass %) |
| Ex. 1-1 | A-1 | 50 | B-1 | 50 | 17 | 11,700 | 72,600 | 22.3 | 6.1 |
| Ex. 1-2 | A-1 | 50 | B-2 | 50 | 35 | 14,200 | 77,400 | 17.1 | 8.6 |
| Ex. 1-3 | A-2 | 50 | B-3 | 50 | 23 | 10,300 | 79,600 | 19.5 | 7.1 |
| Ex. 1-4 | A-1 | 50 | B-4 | 50 | 20 | 15,300 | 71,000 | 16.2 | 7.3 |
| Ex. 1-5 | A-2 | 60 | B-3 | 40 | 16 | 12,900 | 62,000 | 23.3 | 4.9 |
| Ex. 1-6 | A-3 | 50 | B-4 | 50 | 22 | 14,900 | 86,800 | 20.8 | 9.2 |
| Ex. 1-7 | A-3 | 40 | B-4 | 60 | 25 | 15,500 | 82,000 | 16.1 | 8.8 |
| Ex. 1-8 | A-2 | 70 | B-3 | 30 | 15 | 12,100 | 66,000 | 24.5 | 7.1 |
| Comp. | A-1 | 50 | B-5 | 50 | 8 | 9,000 | 92,000 | 26.3 | 5.5 |
| Ex. 1-1 | | | | | | | | | |
| Comp. | A-1 | 35 | B-2 | 65 | 42 | 15,500 | 56,300 | 14.2 | 10.3 |
| Ex. 1-2 | | | | | | | | | |
| Comp. | A-1 | 50 | B-6 | 50 | 7 | 15,000 | 74,000 | 24.0 | 9.0 |
| Ex. 1-3 | | | | | | | | | |
| Comp. | A-2 | 35 | B-2 | 65 | 42 | 15,800 | 63,000 | 16.0 | 9.5 |
| Ex. 1-4 | | | | | | | | | |
| Comp. | A-2 | 60 | B-3 | 40 | 16 | 9,500 | 78,000 | 23.0 | 6.0 |
| Ex. 1-5 | | | | | | | | | |
| Comp. | A-3 | 35 | B-4 | 65 | 30 | 17,500 | 86,000 | 15.2 | 9.5 |
| Ex. 1-6 | | | | | | | | | |
| Comp. | A-2 | 60 | B-7 | 40 | 15 | 12,800 | 57,000 | 25.5 | 4.3 |
| Ex. 1-7 | | | | | | | | | |
| Comp. | A-5 | 50 | B-4 | 50 | 21 | 14,800 | 92,000 | 22.9 | 8.4 |
| Ex. 1-8 | | | | | | | | | |
| Comp. | A-6 | 40 | B-4 | 60 | 26 | 16,700 | 83,000 | 14.5 | 9.2 |
| Ex. 1-9 | | | | | | | | | |
| Comp. | A-2 | 75 | B-3 | 25 | 12 | 16,000 | 85,000 | 26.5 | 6.5 |
| Ex. 1-10 | | | | | | | | | |
| Comp. | A-3 | 40 | B-8 | 60 | 25 | 15,500 | 88,000 | 17.2 | 10.8 |
| Ex. 1-11 | | | | | | | | | |

### (Evaluations)

The following evaluations were performed on the toners obtained above.

### <Cracking Resistance>

After charging a 250 mL plastic container with 50 g of the toner, 120 g of alumina beads having diameters of 10 mm were added to the container, and the toner was stirred for 40 hours at 150 rpm by means of a ball mill. After the stirring, cracking resistance of the toner was evaluated based on the initial particle diameters and an increased amount of a fine powder component after the stirring.

The increased amount of the fine powder component was measured according to the Coulter Counter method. As a measuring device of a particle size distribution of the toner particles, Coulter Multisizer III (available from Beckman Coulter, Inc.) was used.

First, from 0.1 mL through 5 mL of a surfactant (preferably alkylbenzene sulfonic acid salt) serving as a disperser was added to from 100 mL through 150 mL of an electrolyte solution. As the electrolyte solution, an about 1% NaCl aqueous solution was prepared using 1st grade sodium chloride, and ISOTON-II (available from Beckman Coulter, Inc.) was used. Moreover, a measuring sample was added in an amount of from 2 mg through 20 mg based on the solid content. The electrolyte solution, in which the sample was suspended, was subjected to a dispersion treatment for about 1 minute to about 3 minutes by means of a ultrasonic disperser, and the volume and the number of the toner particles or toner were measured by means of the above-mentioned measuring device with an aperture of 100 μm, to thereby calculate a volume distribution and a number distribution. An increased amount of the number % of less than 3.00 μm was evaluated based on the following criteria.

### [Evaluation Criteria]

Very good: The increased amount was less than 4%.
Good: The increased amount was 4% or greater but less than 7%.
Fair: The increased amount was 7% or greater but less than 10%.
Poor: The increased amount was 10% or greater.

### <Evaluation of Blade Adhesion Resistance>

After charging a 250 mL plastic container with 50 g of the toner, 120 g of alumina beads having diameters of 10 mm were added to the container, and the toner was stirred for 40 hours at 150 rpm by means of a ball mill, to thereby produce a deteriorated toner for evaluation. A developing unit of IPSiO SP C220 available from Ricoh Company Limited was charged with 20 g of the deteriorated toner for the evaluation. An evaluation of blade adhesion was then performed by an external idle machine. The blade adhesion was confirmed every 5 minutes by visually observing lines derived from the adhesion in the areas of the developing roller of an image forming section where each area was positioned at 5 cm from each edge of the developing roller. The evaluation criteria are as follows.

### [Evaluation Criteria]

Very good: The timing for the blade adhesion to occur was 120 minutes or later.
Good: The timing for the blade adhesion to occur was 60 minutes or later but before 120 minutes.
Fair: The timing for the blade adhesion to occur was 30 minutes or later but before 60 minutes.
Poor: The timing for the blade adhesion to occur was before 30 minutes.

### <Evaluation of Fixability>

IPSiO SP C220 available from Ricoh Company Limited was modified and the modified device was charged with the toner. The device was set in a manner that a deposition amount of the toner on Type 6000 (long grain) paper available from Ricoh Company Limited was to be 10 g/m², and the paper, on which an unfixed square solid image having a side of 40 mm was formed, was prepared.

Next, the prepared unfixed solid image was passed through a modified fixing unit of IPSiO SP 4510SF available from Ricoh Company Limited with setting system speed to 240 mm/sec, to thereby fix the image. The test was performed by varying the fixing temperature from 120° C. through 200° C. by 5° C. and the image was visually observed whether toner offset occurred or not. The evaluation criteria of the minimum fixing temperature and the maximum fixing temperature are as follows.

### [Evaluation Criteria of Minimum Fixing Temperature]

Very good: The minimum fixing temperature was lower than 130° C.
Good: The minimum fixing temperature was 130° C. or higher but lower than 140° C.
Fair: The minimum fixing temperature was 140° C. or higher but lower than 150° C.
Poor: The minimum fixing temperature was 150° C. or higher.

### [Evaluation Criteria of Fixing Temperature Width]

Very good: The maximum fixing temperature was 210° C. or higher.
Good: The maximum fixing temperature was 190° C. or higher but lower than 210° C.
Fair: The maximum fixing temperature was 170° C. or higher but lower than 190° C.
Poor: The maximum fixing temperature was lower than 170° C.

The evaluation results of Examples and Comparative Examples are presented in Table 4.

As a comprehensive evaluation, the case where the results of all of the evaluation items were “Good” or better was determined as “Very good,” the case where the results of all of the evaluation items were “Fair” or better was determined as “Good,” and the case where the results included one or more “Poor” was determined as “Poor.” “Good” or better is an acceptable level.

TABLE 4

| | | | Blade adhesion | | | | | | |
|---|---|---|---|---|---|---|---|---|---|
| | | | evaluation | | Fixing evaluation | | | | |
| | | | Timing | | Min. | | Max. | | Comprehensive |
| | | Cracking | (min) | Evaluation | (° C.) | Evaluation | (° C.) | Evaluation | evaluation |
| Ex. 1-1 | Toner | Fair | 90 | Good | 120 | Very | 175 | Fair | Good |
| | 1-1 | | | | | good | | | |
| Ex. 1-2 | Toner | Very good | 125 | Very | 135 | Good | 220 | Very | Very good |
| | 1-2 | | | good | | | | good | |
| Ex. 1-3 | Toner | Fair | 75 | Good | 125 | Very | 185 | Fair | Good |
| | 1-3 | | | | | good | | | |
| Ex. 1-4 | Toner | Good | 105 | Good | 145 | Fair | 200 | Good | Good |
| | 1-4 | | | | | | | | |
| Ex. 1-5 | Toner | Fair | 50 | Fair | 125 | Very | 205 | Good | Good |
| | 1-5 | | | | | good | | | |
| Ex. 1-6 | Toner | Good | 135 | Very | 145 | Fair | 190 | Good | Good |
| | 1-6 | | | good | | | | | |
| Ex. 1-7 | Toner | Good | 100 | Good | 145 | Fair | 195 | Good | Good |
| | 1-7 | | | | | | | | |
| Ex. 1-8 | Toner | Fair | 45 | Fair | 125 | Very | 185 | Fair | Good |
| | 1-8 | | | | | good | | | |
| Comp. | Comp. | Poor | 50 | Fair | 120 | Very | 165 | Poor | Poor |
| Ex. 1-1 | Toner | | | | | good | | | |
| | 1-1 | | | | | | | | |
| Comp. | Comp. | Fair | 25 | Poor | 155 | Poor | 220 | Very | Poor |
| Ex. 1-2 | Toner | | | | | | | good | |
| | 1-2 | | | | | | | | |
| Comp. | Comp. | Fair | 90 | Good | 145 | Fair | 165 | Poor | Poor |
| Ex. 1-3 | Toner | | | | | | | | |
| | 1-3 | | | | | | | | |
| Comp. | Comp. | Good | 105 | Good | 155 | Poor | 220 | Very | Poor |
| Ex. 1-4 | Toner | | | | | | | good | |
| | 1-4 | | | | | | | | |
| Comp. | Comp. | Fair | 25 | Poor | 120 | Very | 185 | Fair | Poor |
| Ex. 1-5 | Toner | | | | | good | | | |
| | 1-5 | | | | | | | | |
| Comp. | Comp. | Good | 110 | Good | 155 | Poor | 220 | Very | Poor |
| Ex. 1-6 | Toner | | | | | | | good | |
| | 1-6 | | | | | | | | |
| Comp. | Comp. | Poor | 20 | Poor | 120 | Very | 190 | Good | Poor |
| Ex. 1-7 | Toner | | | | | good | | | |
| | 1-7 | | | | | | | | |
| Comp. | Comp. | Good | 135 | Very | 155 | Poor | 200 | Good | Poor |
| Ex. 1-8 | Toner | | | good | | | | | |
| | 1-8 | | | | | | | | |
| Comp. | Comp. | Good | 100 | Good | 155 | Poor | 200 | Good | Poor |
| Ex. 1-9 | Toner | | | | | | | | |
| | 1-9 | | | | | | | | |
| Comp. | Comp. | Fair | 25 | Poor | 125 | Very | 165 | Poor | Poor |
| Ex. 1-10 | Toner | | | | | good | | | |
| | 1-10 | | | | | | | | |
| Comp. | Comp. | Good | 135 | Very | 155 | Poor | 200 | Good | Poor |
| Ex. 1-11 | Toner | | | good | | | | | |
| | 1-11 | | | | | | | | |

### Example 2-1

After sufficiently mixing a mixture having the following composition in Henschel Mixer, the resultant was heated and melted for about 30 minutes at a temperature of from 130° C. through 140° C. by means of a roll mill. After cooling the resultant to room temperature, the obtained kneaded product was pulverized by means of a jet mill or a mechanical pulverizer and classified by means of an air classifier to thereby obtain toner base particles.

### —Composition—

Polyester Resin A-1: 50 parts
Polyester Resin B-1: 50 parts
Carnauba/rice wax mixture (WA-05, available from CERARICA NODACo., Ltd., endothermic onset temperature: 72.5° C.): 3 parts
Carbon black (#44, available from Mitsubishi Chemical Corporation): 10 parts
Metal-containing azo compound (T-77, available from Hodogaya Chemical Co., Ltd.): 1 part

To obtained toner base particles, 0.5% by mass of hydrophobic silica was added, to thereby obtain Toner 2-1.

### Example 2-2

Toner 2-2 was obtained in the same manner as in Example 2-1, except that [Polyester Resin B-1] was changed to [Polyester Resin B-2].

### Example 2-3

Toner 2-3 was obtained in the same manner as in Example 2-1, except that [Polyester Resin A-1] was changed to [Polyester Resin A-2] and [Polyester Resin B-1] was changed to [Polyester Resin B-3].

### Example 2-4

Toner 2-4 was obtained in the same manner as in Example 2-1, except that [Polyester Resin B-1] was changed to [Polyester Resin B-4].

### Example 2-5

Toner 2-5 was obtained in the same manner as in Example 2-1, except that the types and amounts of the binder resins were changed to 60 parts by mass of [Polyester Resin A-2] and 40 parts by mass of [Polyester Resin B-3].

### Example 2-6

Toner 2-6 was obtained in the same manner as in Example 2-1, except that [Polyester Resin A-1] was changed to [Polyester Resin A-3] and [Polyester Resin B-1] was changed to [Polyester Resin B-4].

### Example 2-7

Toner 2-7 was obtained in the same manner as in Example 2-1, except that the types and amounts of the binder resins were changed to 40 parts by mass of [Polyester Resin A-3] and 60 parts by mass of [Polyester Resin B-4].

### Example 2-8

Toner 2-8 was obtained in the same manner as in Example 2-1, except that the types and amounts of the binder resins were changed to 70 parts by mass of [Polyester Resin A-2] and 30 parts by mass of [Polyester Resin B-3].

### Example 2-9

Toner 2-9 was obtained in the same manner as in Example 2-1, except that the type of wax was changed to the synthesized monoester wax having an endothermic onset temperature of 52.3° C.

### Example 2-10

Toner 2-10 was obtained in the same manner as in Example 2-1, except that the type of the wax was changed to rice wax (TOWAX-3F16, available from TOAKASEI CO., LTD., endothermic onset temperature: 59.2° C.) before re-refining.

### Example 2-11

Toner 2-11 was obtained in the same manner as in Example 2-1, except that the type of the wax was changed to synthesized monoester wax having an endothermic onset temperature of 72.1° C.

### Example 2-12

Toner 2-12 was obtained in the same manner as in Example 2-1, except that the amount of the wax added was changed to 0.5 parts by mass.

### Example 2-13

Toner 2-13 was obtained in the same manner as in Example 2-1, except that the amount of the wax added was changed to 7 parts by mass.

### Example 2-14

Toner 2-14 was obtained in the same manner as in Example 2-1, except that the type of the wax was changed to paraffin wax (HNP-9, available from NIPPON SEIRO CO., LTD., endothermic onset temperature: 60.4° C.).

### Comparative Example 2-1

Comparative Toner 2-1 was obtained in the same manner as in Example 2-1, except that [Polyester Resin B-1] was changed to [Polyester Resin B-5] and the type of the wax was changed to rice wax (endothermic onset temperature: 66.3° C.).

### Comparative Example 2-2

Comparative Toner 2-2 was obtained in the same manner as in Example 2-1, except that the types and amounts of the binder resins were changed to 35 parts by mass of [Polyester Resin A-1] and 65 parts by mass of [Polyester Resin B-2] and the type of the wax was changed to rice wax (endothermic onset temperature: 66.3° C.).

### Comparative Example 2-3

Comparative Toner 2-3 was obtained in the same manner as in Example 2-1, except that the types and amounts of the binder resins were changed to 65 parts by mass of [Polyester Resin A-2] and 35 parts by mass of [Polyester Resin B-3] and the type of the wax was changed to rice wax (endothermic onset temperature: 66.3° C.).

### Comparative Example 2-4

Comparative Toner 2-4 was obtained in the same manner as in Example 2-1, except that the types and amounts of the binder resins were changed to 35 parts by mass of [Polyester Resin A-1] and 65 parts by mass of [Polyester Resin B-4] and the type of the wax was changed to rice wax (endothermic onset temperature: 66.3° C.).

### Comparative Example 2-5

Comparative Toner 2-5 was obtained in the same manner as in Example 2-1, except that [Polyester Resin A-1] was changed to [Polyester Resin A-2], [Polyester Resin B-1] was changed to [Polyester Resin B-5], and the type of the wax was changed to rice wax (endothermic onset temperature: 66.3° C.).

### Comparative Example 2-6

Comparative Toner 2-6 was obtained in the same manner as in Example 2-1, except that [Polyester Resin A-1] was changed to [Polyester Resin A-3], [Polyester Resin B-1] was changed to [Polyester Resin B-4], and the type of the wax was changed to rice wax (endothermic onset temperature: 66.3° C.).

### Comparative Example 2-7

Comparative Toner 2-7 was obtained in the same manner as in Example 2-1, except that the types and amounts of the binder resins were changed to 45 parts by mass of [Polyester Resin A-4] and 55 parts by mass of [Polyester Resin B-4] and the type of the wax was changed to rice wax (endothermic onset temperature: 66.3° C.).

### Comparative Example 2-8

Comparative Toner 2-8 was obtained in the same manner as in Example 2-1, except that the types and amounts of the binder resins were changed to 70 parts by mass of [Polyester Resin A-2] and 30 parts by mass of [Polyester Resin B-5] and the type of the wax was changed to rice wax (endothermic onset temperature: 66.3° C.).

### Comparative Example 2-9

Comparative Toner 2-9 was obtained in the same manner as in Example 2-1, except that the types and amounts of the binder resins were changed to 40 parts by mass of [Polyester Resin A-1] and 60 parts by mass of [Polyester Resin B-6] and the type of the wax was changed to rice wax (endothermic onset temperature: 66.3° C.).

### Comparative Example 2-10

Comparative Toner 2-10 was obtained in the same manner as in Example 2-1, except that [Polyester Resin A-1] was changed to [Polyester Resin A-2], [Polyester Resin B-1] was changed to [Polyester Resin B-4], and the type of the wax was changed to rice wax (endothermic onset temperature: 663° C.)

### Comparative Example 2-11

Comparative Toner 2-11 was obtained in the same manner as in Example 2-1, except that the types and amounts of the binder resins were changed to 65 parts by mass of [Polyester Resin A-2] and 35 parts by mass of [Polyester Resin B-5] and the type of the wax was changed to rice wax (endothermic onset temperature: 66.3° C.).

### Comparative Example 2-12

Comparative Toner 2-12 was obtained in the same manner as in Example 2-1, except that [Polyester Resin A-1] was changed to [Polyester Resin A-4] and the type of the wax was changed to rice wax (endothermic onset temperature: 66.3° C.).

### Comparative Example 2-13

Comparative Toner 2-13 was obtained in the same manner as in Example 2-1, except that the types and amounts of the binder resins were changed to 30 parts by mass of [Polyester Resin A-4] and 70 parts by mass of [Polyester Resin B-5] and the type of the wax was changed to rice wax (endothermic onset temperature: 66.3° C.).

### (Measurements)

The following measurements were performed on the toners obtained above.

### <THF-Insoluble Component>

The toner was weighed by about 50 mg. To the toner, 10 g of THF was added. The toner was sufficiently dissolved to prepare a toner solution. The toner solution was separated by centrifugation. Then, the supernatant was dried and a solid content of the supernatant was calculated. A difference between the solid content of the toner solution initially prepared and the solid content of the supernatant was determined as a THF-insoluble component.

### <THF-Soluble Component>

The toner was weighed by 50 mg. To the toner, 10 g of THF was added. The toner was sufficiently dissolved to prepare a solution. The solution was separated by centrifugation. Then, the supernatant was dried and a solid content mass [X (mg)] of the supernatant was determined.

Moreover, an amount (% by mass) of the THF-soluble component of the toner was determined by Formula (1) below.

THF-soluble component (% by mass) of the toner=X/50 mg×100 Formula (1)

Note that, the solid content of the supernatant is an equivalent of the THF-soluble component.

### <<GPC Measurement>>

Gel permeation chromatography (GPC) was performed on the THF-soluble component of each of the toners obtained above under the following conditions.
Device: GPC-150C (available from Waters)
Columns: KF801 to 807 (available from Showdex)
Temperature: 40° C.
Solvent: tetrahydrofuran (THF)
Flow rate: 1.0 mL/min
Sample: A sample having a concentration of from 0.05% through 0.6% was injected by 0.1 mL.

A number average molecular weight and weight average molecular weight of the resin were calculated from a molecular weight distribution measured under the conditions above using a molecular weight calibration curve produced with monodisperse polystyrene standard samples.

As the standard polystyrene samples for forming a calibration curve, for example, Showdex STANDARD Std. Nos. S-7300, S-210, S-390, S-875, S-1980, S-10.9, S-629, S-3.0, and S-0.580, available from SHOWA DENKO K.K., and toluene were used. As a detector, a refractive index (RI) was used.

### <Measurement of Endothermic Onset Temperature of Wax>

For a measurement of a melting point of wax for use, a differential scanning calorimeter (DSC-6220R, available from Seiko Instruments Inc.) was used. First, a sample was heated from room temperature to 150° C. at heating speed of 10° C./min, followed by leaving for 10 minutes at 150° C. Thereafter, the sample was cooled to room temperature and left for 10 min. The sample was again heated to 150° C. at heating speed of 10° C./min. During this process, a cross point between the base line and a tangent of an inflection point was taken and the cross point was determined as an endothermic onset temperature.

A list of physical properties of the obtained toners are presented in Table 5.

TABLE 5

| | | | | | Physical properties of toner | | | | | | | |
|---|---|---|---|---|---|---|---|---|---|---|---|---|
| | | | | | | THF-soluble component | | | | | | |
| | | | | | | | | Amount of | Amount of | WAX | | |
| | | | | | THF- | | | component | component | | Endothermic | |
| | | | | | insoluble | Peak tope | Half | of 2,000 or | of 100,000 | | onset | |
| | Resin type | | | | component | molecular | value | less | or greater | | temperature | Amount |
| | Resin A | | Resin B | | (mass %) | weight | width | (mass %) | (mass %) | Type | (° C.) | (parts) |
| Ex. 2-1 | A -1 | 50 | B-1 | 50 | 17 | 11,000 | 72,400 | 22.0 | 6.0 | Carnauba/rice | 72.5 | 3 |
| | | | | | | | | | | wax mix | | |
| Ex. 2-2 | A-1 | 50 | B-2 | 50 | 35 | 14,500 | 77,600 | 17.0 | 8.4 | Carnauba/rice | 72.5 | 3 |
| | | | | | | | | | | wax mix | | |
| Ex. 2-3 | A-2 | 50 | B-3 | 50 | 24 | 10,400 | 79,400 | 19.8 | 7.1 | Carnauba/rice | 72.5 | 3 |
| | | | | | | | | | | wax mix | | |
| Ex. 2-4 | A-1 | 50 | B-4 | 50 | 21 | 15,600 | 73,000 | 16.5 | 7.0 | Carnauba/rice | 72.5 | 3 |
| | | | | | | | | | | wax mix | | |
| Ex. 2-5 | A-2 | 60 | B-3 | 40 | 18 | 12,900 | 63,100 | 23.8 | 5.0 | Carnauba/rice | 72.5 | 3 |
| | | | | | | | | | | wax mix | | |
| Ex. 2-6 | A-3 | 50 | B-4 | 50 | 22 | 15,100 | 87,200 | 21.8 | 9.3 | Carnauba/rice | 72.5 | 3 |
| | | | | | | | | | | wax mix | | |
| Ex. 2-7 | A-3 | 40 | B-4 | 60 | 26 | 15,500 | 82,500 | 16.2 | 9.0 | Carnauba/rice | 72.5 | 3 |
| | | | | | | | | | | wax mix | | |
| Ex. 2-8 | A-2 | 70 | B-3 | 30 | 16 | 12,200 | 68,200 | 24.3 | 7.0 | Carnauba/rice | 72.5 | 3 |
| | | | | | | | | | | wax mix | | |
| Ex. 2-9 | A-1 | 50 | B-1 | 50 | 17 | 10,800 | 71,500 | 23.1 | 6.0 | Synthetic ester | 52.3 | 3 |
| Ex. 2-10 | A-1 | 50 | B-1 | 50 | 17 | 11,400 | 72,200 | 23.2 | 6.0 | Rice wax | 59.2 | 3 |
| Ex. 2-11 | A-1 | 50 | B-1 | 50 | 17 | 12,100 | 74,200 | 21.8 | 6.0 | Synthetic ester | 72.1 | 3 |
| Ex. 2-12 | A-1 | 50 | B-1 | 50 | 16 | 12,600 | 70,800 | 23.6 | 6.0 | Carnauba/rice | 72.5 | 0.5 |
| | | | | | | | | | | wax mix | | |
| Ex. 2-13 | A-1 | 50 | B-1 | 50 | 17 | 10,800 | 73,100 | 20.9 | 6.0 | Carnauba/rice | 72.5 | 7 |
| | | | | | | | | | | wax mix | | |
| Ex. 2-14 | A-1 | 50 | B-1 | 50 | 17 | 11,000 | 70,600 | 23.0 | 5.0 | Paraffin wax | 60.4 | 3 |
| Comp. | A-1 | 50 | B-5 | 50 | 8 | 12,300 | 68,700 | 21.8 | 5.6 | Rice wax | 66.3 | 3 |
| Ex. 2-1 | | | | | | | | | | | | |
| Comp. | A-1 | 35 | B-2 | 65 | 42 | 17,600 | 78,700 | 16.9 | 8.0 | Rice wax | 66.3 | 3 |
| Ex. 2-2 | | | | | | | | | | | | |
| Comp. | A-2 | 65 | B-3 | 35 | 13 | 9,600 | 67,800 | 20.5 | 3.0 | Rice wax | 66.3 | 3 |
| Ex. 2-3 | | | | | | | | | | | | |
| Comp. | A-1 | 35 | B-4 | 65 | 23 | 16,800 | 79,700 | 18.6 | 7.0 | Rice wax | 66.3 | 3 |
| Ex. 2-4 | | | | | | | | | | | | |
| Comp. | A-2 | 50 | B-5 | 50 | 17 | 14,800 | 57,200 | 23.9 | 5.8 | Rice wax | 66.3 | 3 |
| Ex. 2-5 | | | | | | | | | | | | |
| Comp. | A-3 | 50 | B-4 | 50 | 29 | 17,800 | 102,000 | 15.5 | 11.6 | Rice wax | 66.3 | 3 |
| Ex. 2-6 | | | | | | | | | | | | |
| Comp. | A-4 | 45 | B-4 | 55 | 30 | 17,000 | 48,000 | 8.1 | 9.2 | Rice wax | 66.3 | 3 |
| Ex. 2-7 | | | | | | | | | | | | |
| Comp. | A-2 | 70 | B-5 | 30 | 11 | 12,500 | 22,000 | 22.5 | 1.8 | Rice wax | 66.3 | 3 |
| Ex. 2-8 | | | | | | | | | | | | |
| Comp. | A-1 | 40 | B-6 | 60 | 44 | 15,800 | 75,000 | 17.3 | 7.6 | Rice wax | 66.3 | 3 |
| Ex. 2-9 | | | | | | | | | | | | |
| Comp. | A-2 | 50 | B-4 | 50 | 28 | 15,500 | 112,000 | 18.4 | 8.8 | Rice wax | 66.3 | 3 |
| Ex. 2-10 | | | | | | | | | | | | |
| Comp. | A-2 | 65 | B-5 | 35 | 14 | 12,000 | 83,000 | 27.6 | 5.5 | Rice wax | 66.3 | 3 |
| Ex. 2-11 | | | | | | | | | | | | |
| Comp. | A-4 | 50 | B-1 | 50 | 13 | 11,500 | 65,000 | 13.5 | 1.6 | Rice wax | 66.3 | 3 |
| Ex. 2-12 | | | | | | | | | | | | |
| Comp. | A-4 | 30 | B-5 | 70 | 33 | 13,300 | 73,000 | 17.1 | 12.3 | Rice wax | 66.3 | 3 |
| Ex. 2-13 | | | | | | | | | | | | |

### (Evaluations)

The following evaluations were performed on the toners obtained above.

### <Evaluation of Blade Adhesion Resistance>

After charging a 250 mL plastic container with 50 g of the toner, 120 g of alumina beads having diameters of 10 mm were added to the container, and the toner was stirred for 40 hours at 150 rpm by means of a ball mill, to thereby produce a deteriorated toner for evaluation. A developing unit of IPSiO SP C220 available from Ricoh Company Limited was charged with 20 g of the deteriorated toner for the evaluation. An evaluation of blade adhesion was then performed by an external idle machine. The blade adhesion was confirmed every 5 minutes by visually observing lines derived from the adhesion in the areas of the developing roller of an image forming section where each area was positioned at 5 cm from each edge of the developing roller. The evaluation criteria are as follows.

### [Evaluation Criteria]

Very good: The timing for the blade adhesion to occur was 150 minutes or later.
Good: The timing for the blade adhesion to occur was 120 minutes or later but before 150 minutes.
Fair: The timing for the blade adhesion to occur was 60 minutes or later but before 120 minutes.
Poor: The timing for the blade adhesion to occur was before 60 minutes.

### <Evaluation of Fixability>

IPSiO SP C220 available from Ricoh Company Limited was modified and the modified device was charged with the toner. The device was set in a manner that a deposition amount of the toner on Type 6000 (long grain) paper available from Ricoh Company Limited was to be 10 g/m², and the paper, on which an unfixed square solid image having a side of 40 mm was formed, was prepared.

Next, the prepared unfixed solid image was passed through a modified fixing unit of IPSiO SP 4510SF available from Ricoh Company Limited with setting system speed to 240 mm/sec, to thereby fix the image. The test was performed by varying the fixing temperature from 120° C. through 220° C. by 2° C. and the image was visually observed whether toner offset occurred or not. The evaluation criteria of the minimum fixing temperature and the maximum fixing temperature are as follows.

### [Evaluation Criteria of Minimum Fixing Temperature]

Very good: The minimum fixing temperature was lower than 130° C.
Good: The minimum fixing temperature was 130° C. or higher but lower than 140° C.
Fair: The minimum fixing temperature was 140° C. or higher but lower than 150° C.
Poor: The minimum fixing temperature was 150° C. or higher.

### [Evaluation Criteria of Fixing Temperature Width]

Very good: The maximum fixing temperature was 210° C. or higher.
Good: The maximum fixing temperature was 190° C. or higher but lower than 210° C.
Fair: The maximum fixing temperature was 170° C. or higher but lower than 190° C.
Poor: The maximum fixing temperature was lower than 170° C.

The evaluation results of Examples and Comparative Examples are presented in Table 6.

As a comprehensive evaluation, the case where the results of all of the evaluation items were “Good” or better was determined as “Very good,” the case where the results of all of the evaluation items were “Fair” or better was determined as “Good,” and the case where the results included one or more “Poor” was determined as “Poor.” “Good” and “Very good” are acceptable levels and “Very good” represents the better result than “Good.”

TABLE 6

| | | Blade adhesion | | | | | | |
|---|---|---|---|---|---|---|---|---|
| | | evaluation | | Fixing evaluation | | | | |
| | | Timing | | Min | | Max | | Comprehensive |
| | | (min) | Evaluation | (° C.) | Evaluation | (° C.) | Evaluation | Evaluation |
| Ex. 2-1 | Toner 2-1 | 125 | Good | 132 | Good | 194 | Good | Good |
| Ex. 2-2 | Toner 2-2 | 165 | Very good | 142 | Pair | 210 | Very good | Good |
| Ex. 2-3 | Toner 2-3 | 75 | Fair | 126 | Very good | 182 | Fair | Good |
| Ex. 2-4 | Toner 2-4 | 155 | Very good | 142 | Fair | 215 | Very good | Good |
| Ex. 2-5 | Toner 2-5 | 65 | Fair | 128 | Very good | 194 | Good | Good |
| Ex. 2-6 | Toner 2-6 | 170 | Very good | 148 | Fair | 194 | Good | Good |
| Ex. 2-7 | Toner 2-7 | 160 | Very good | 144 | Fair | 206 | Good | Good |
| Ex. 2-8 | Toner 2-8 | 65 | Fair | 124 | Very good | 192 | Good | Good |
| Ex. 2-9 | Toner 2-9 | 70 | Fair | 134 | Good | 212 | Very good | Good |
| Ex. 2-10 | Toner 2-10 | 80 | Fair | 132 | Good | 196 | Good | Good |
| Ex. 2-11 | Toner 2-11 | 110 | Fair | 138 | Good | 178 | Fair | Good |
| Ex. 2-12 | Toner 2-12 | 185 | Very good | 134 | Good | 172 | Fair | Good |
| Ex. 2-13 | Toner 2-13 | 65 | Fair | 124 | Very good | 190 | Good | Good |
| Ex. 2-14 | Toner 2-14 | 120 | Good | 128 | Very good | 192 | Good | Very good |
| Comp. | Comp. | 90 | Fair | 126 | Very good | 166 | Poor | Poor |
| Ex. 2-1 | Toner 2-1 | | | | | | | |
| Comp. | Comp. | 170 | Very good | 154 | Poor | 216 | Very good | Poor |
| Ex. 2-2 | Toner 2-2 | | | | | | | |
| Comp. | Comp. | 45 | Poor | 120 | Very good | 174 | Fair | Poor |
| Ex. 2-3 | Toner 2-3 | | | | | | | |
| Comp. | Comp. | 160 | Very good | 152 | Poor | 194 | Good | Poor |
| Ex. 2-4 | Toner 2-4 | | | | | | | |
| Comp. | Comp. | 50 | Poor | 122 | Very good | 172 | Fair | Poor |
| Ex. 2-5 | Toner 2-5 | | | | | | | |
| Comp. | Comp. | 160 | Very good | 158 | Poor | 214 | Very good | Poor |
| Ex. 2-6 | Toner 2-6 | | | | | | | |
| Comp. | Comp. | 145 | Good | 152 | Poor | 204 | Good | Poor |
| Ex. 2-7 | Toner 2-7 | | | | | | | |
| Comp. | Comp. | 40 | Poor | 120 | Very good | 172 | Fair | Poor |
| Ex. 2-8 | Toner 2-8 | | | | | | | |
| Comp. | Comp. | 180 | Very good | 158 | Poor | 220 | Very good | Poor |
| Ex. 2-9 | Toner 2-9 | | | | | | | |
| Comp. | Comp. | 135 | Good | 152 | Poor | 192 | Good | Poor |
| Ex. 2-10 | Toner 2-10 | | | | | | | |
| Comp. | Comp. | 40 | Poor | 120 | Very good | 168 | Poor | Poor |
| Ex. 2-11 | Toner 2-11 | | | | | | | |
| Comp. | Comp. | 140 | Good | 156 | Poor | 198 | Good | Poor |
| Ex. 2-12 | Toner 2-12 | | | | | | | |
| Comp. | Comp. | 165 | Very good | 160 | Poor | 212 | Very good | Poor |
| Ex. 2-13 | Toner 2-13 | | | | | | | |

### Example 3-1

After sufficiently stirring a mixture having the following composition in Henschel Mixer, the resultant was melt-kneaded by a twin screw extrusion kneader (TEM-18SS, available from TOSHIBA MACHINE CO., LTD.). After cooling the resultant to room temperature, the obtained kneaded product was pulverized by a jet mill (IDS-2, available from Nippon Pneumatic Mfg. Co., Ltd.) and classified by a rotor classifier (50ATP, available from Hosokawa Micron Corporation), to thereby obtain toner base particles having an average particle diameter of 8 μm.

### —Composition—

Polyester Resin A-1: 50 parts
Polyester Resin B-1: 50 parts
Rice wax (TOWAX-3F16, available from TOAKASEI CO., LTD.): 5 parts
Carbon black (#44, available from Mitsubishi Chemical Corporation): 10 parts
Azo iron compound (T-77, available from Hodogaya Chemical Co., Ltd., referred to as [CCA1]): 1.8 parts

To 100 parts by mass of the obtained toner base particles, 2 parts by mass of HMDS-treated hydrophobic silica (RX200, available from NIPPON AEROSIL CO., LTD.) having a particle size of 12 nm was added, to thereby obtain [Toner 3-1]. The physical properties of the toner are presented in Table 7.

### Examples 3-2 to 3-13 and Comparative Examples 3-1 to 3-11

Each toner was obtained in the same manner as in Example 3-1, except that the toner composition was changed to the toner composition presented in Table 7.

### (Measurements)

The following measurements were performed on the toners obtained above.

### <THF-Insoluble Component>

The toner was weighed by about 50 mg. To the toner, 10 g of THF was added. The toner was sufficiently dissolved to prepare a toner solution. The toner solution was separated by centrifugation. Then, the supernatant was dried and a solid content of the supernatant was calculated. A difference between the solid content of the toner solution initially prepared and the solid content of the supernatant was determined as a THF-insoluble component.

### <THF-Soluble Component>

The toner was weighed by 50 mg. To the toner, 10 g of THF was added. The toner was sufficiently dissolved to prepare a solution. The solution was separated by centrifugation. Then, the supernatant was dried and a solid content mass [X (mg)] of the supernatant was determined.

Moreover, an amount (% by mass) of the THF-soluble component of the toner was determined by Formula (1) below.

THF-soluble component (% by mass) of the toner=X/50 mg×100 Formula (1)

Note that, the solid content of the supernatant is an equivalent of the THF-soluble component.

### <<GPC Measurement>>

Gel permeation chromatography (GPC) was performed on the THF-soluble component of each of the toners obtained above under the following conditions.
Device: GPC-150C (available from Waters)
Columns: KF801 to 807 (available from Showdex)
Temperature: 40° C.
Solvent: tetrahydrofuran (THF)
Flow rate: 1.0 mL/min
Sample: A sample having a concentration of from 0.05% through 0.6% was injected by 0.1 mL.

A number average molecular weight and weight average molecular weight of the resin were calculated from a molecular weight distribution measured under the conditions above using a molecular weight calibration curve produced with monodisperse polystyrene standard samples.

As the standard polystyrene samples for forming a calibration curve, for example, Showdex STANDARD Std. Nos. S-7300, S-210, S-390, S-875, S-1980, S-10.9, S-629, S-3.0, and S-0.580, available from SHOWA DENKO K.K., and toluene were used. As a detector, a refractive index (RI) was used.

TABLE 7

| | | | | | Physical properties of toner | | | | | | | |
|---|---|---|---|---|---|---|---|---|---|---|---|---|
| | | | | | | THF-soluble component | | | | | | |
| | | | | | | | | Amount of | Amount of | | | |
| | Resin type | | | | THF- | | | component | component | CCA | | |
| | Resin A | | Resin B | | insoluble | Peak top | Half | of 2,000 or | of 100,000 | | Amount | |
| | | mass | | mass | component | molecular | value | less | or greater | | (mass | |
| | type | parts | type | parts | (mass %) | weight | width | (mass %) | (mass %) | Type | parts) | |
| Ex. 3-1 | A-1 | 50 | B-1 | 50 | 17 | 11,700 | 72,600 | 22.3 | 6.1 | CCA1 | 1.8 | Toner 3-1 |
| Ex. 3-2 | A-1 | 30 | B-2 | 00 | 80 | 14,200 | 77,400 | 17.1 | 8.6 | CCA1 | 1.8 | Toner 8-2 |
| Ex. 3-3 | A-2 | 50 | B-3 | 50 | 23 | 10,300 | 79,600 | 19.5 | 7.1 | CCA1 | 1.8 | Toner 3-3 |
| Ex. 3-4 | A-1 | 50 | B-4 | 50 | 20 | 15,300 | 71,000 | 16.2 | 7.3 | CCA1 | 1.8 | Toner 3-4 |
| Ex. 3-5 | A-2 | 60 | B-3 | 40 | 16 | 12,900 | 62,000 | 23.3 | 4.9 | CCA1 | 1.8 | Toner 3-5 |
| Ex. 3-6 | A-3 | 50 | B-4 | 50 | 22 | 14,900 | 86,800 | 20.8 | 9.2 | CCA1 | 1.8 | Tone 3-6 |
| Ex. 3-7 | A-3 | 40 | B-4 | 60 | 25 | 15,500 | 82,000 | 16.1 | 8.8 | CCA1 | 1.8 | Toner 3-7 |
| Ex. 3-8 | A-2 | 70 | B-3 | 30 | 15 | 12,100 | 66,000 | 24.5 | 7.1 | CCA1 | 1.8 | Toner 3-8 |
| Ex. 3-9 | A-1 | 50 | B-1 | 50 | 17 | 11,700 | 72,600 | 22.3 | 6.1 | CCA1 | 0.5 | Toner 3-9 |
| Ex. 3-10 | A-1 | 50 | B-1 | 50 | 17 | 11,700 | 72,600 | 22.3 | 6.1 | CCA1 | 3.0 | Toner 3-10 |
| Ex. 3-11 | A-1 | 50 | B-1 | 50 | 17 | 11,700 | 72,600 | 22.3 | 6.1 | CCA2 | 1.8 | Toner 3-11 |
| Ex. 3-12 | A-1 | 50 | B-1 | 50 | 17 | 11,700 | 72,600 | 22.3 | 6.1 | CCA1 | 0.3 | Toner 3-12 |
| Ex. 3-13 | A-1 | 50 | B-1 | 50 | 17 | 11,700 | 72,800 | 22.3 | 8.1 | CCA1 | 4.0 | Toner 3-13 |
| Comp. | A-1 | 50 | B-5 | 50 | 8 | 9,000 | 92,000 | 26.3 | 5.5 | CCA1 | 1.8 | Comp. |
| Ex. 3-1 | | | | | | | | | | | | Toner 3-1 |
| Comp. | A-1 | 35 | B-2 | 65 | 42 | 16,500 | 56,300 | 14.2 | 10.3 | CCA1 | 1.8 | Comp. |
| Ex. 3-2 | | | | | | | | | | | | Toner 3-2 |
| Comp. | A-1 | 50 | B-6 | 50 | 7 | 15,000 | 74,000 | 24.0 | 9.0 | CCA1 | 1.8 | Comp. |
| Ex. 3-3 | | | | | | | | | | | | Toner 3-3 |
| Comp. | A-2 | 35 | B-2 | 65 | 42 | 15,800 | 63,000 | 16.0 | 9.5 | CCA1 | 1.8 | Comp. |
| Ex. 3-4 | | | | | | | | | | | | Toner 3-4 |
| Comp. | A-2 | 60 | B-3 | 40 | 16 | 9,500 | 78,000 | 23.0 | 6.0 | CCA1 | 1.8 | Comp. |
| Ex. 3-5 | | | | | | | | | | | | Toner 3-5 |
| Comp. | A-3 | 35 | B-4 | 65 | 30 | 17,500 | 86,000 | 15.2 | 9.5 | CCA1 | 1.8 | Comp. |
| Ex. 3-6 | | | | | | | | | | | | Toner 8-6 |
| Comp. | A-2 | 80 | B-7 | 40 | 15 | 12,800 | 57,000 | 25.5 | 4.3 | CCA1 | 1.8 | Comp. |
| Ex. 3-7 | | | | | | | | | | | | Toner 3-7 |
| Comp. | A-5 | 50 | B-4 | 50 | 21 | 14,800 | 92,000 | 22.9 | 8.4 | CCA1 | 1.8 | Comp. |
| Ex. 3-8 | | | | | | | | | | | | Toner 3-8 |
| Comp. | A-6 | 40 | B-4 | 60 | 26 | 16,700 | 83,000 | 14.5 | 9.2 | CCA1 | 1.8 | Comp. |
| Ex. 3-9 | | | | | | | | | | | | Toner 3-9 |
| Comp. | A-2 | 75 | B-3 | 25 | 12 | 16,000 | 85,000 | 26.5 | 6.5 | CCA1 | 1.8 | Comp. |
| Ex. 3-10 | | | | | | | | | | | | Toner 3-10 |
| Comp. | A-3 | 40 | B-8 | 60 | 25 | 15,500 | 88,000 | 17.2 | 10.8 | CCA1 | 1.8 | Comp. |
| Ex. 3-11 | | | | | | | | | | | | Toner 3-11 |

The physical properties and evaluation results of the toners obtained above are presented in Table 7. Note that, in Table 7, “CCA amount (part(s) by mass)” denotes an amount (part(s) by mass) relative to 100 parts by mass of the binder resins.

CCA2 is a compound where J+ is an alkyl ammonium ion in Structural Formula (2) above.

CCA3 is TN-105 available from Hodogaya Chemical Co., Ltd.

### (Evaluations)

The following evaluations were performed on the toners obtained above.

### <Evaluation of Background Smear>

IPSiO SP C220 available from Ricoh Company Limited was modified. The modified device was charged with 13.5 g of the deteriorated toner produced in the evaluation of blade adhesion resistance, and SCOTCH TAPE was adhered to an entire surface of an exposed area of a photoconductor operation of which was suspended during printing of a blank sheet. The peeled SCOTCH TAPE was adhered to Type 6000 (long grain) paper available from Ricoh Company Limited and was then stored. A value of L* on the tape was measured by X-rite (available from Videojet X-Rite K.K.). Evaluation criteria are as described below.

### [Evaluation Criteria]

Very good: L* was 91.0 or greater.
Good: L* was 89.0 or greater but less than 91.0.
Fair: L* was 85.0 or greater but less than 89.0.
Poor: L* was less than 85.0.

### <Evaluation of Fixability>

### —Low-Temperature Fixability—

IPSiO SP C220 available from Ricoh Company Limited was modified and the modified device was charged with the toner. The device was set in a manner that a deposition amount of the toner on Type 6000 (long grain) paper available from Ricoh Company Limited was to be 10 g/m², and the paper, on which an unfixed square solid image having a side of 40 mm was formed, was prepared.

Next, the prepared unfixed solid image was passed through a modified fixing unit of IPSiO SP 4510SF available from Ricoh Company Limited with setting system speed to 240 mm/sec, to thereby fix the image. The test was performed by varying the fixing temperature from 120° C. through 160° C. by 2° C. The output images were visually observed and the temperature at which unintentional toner transfer did not occur on the white background region was determined as the minimum fixing temperature. Evaluation criteria are as follows.

### [Evaluation Criteria]

Very good: The minimum fixing temperature was lower than 130° C.
Good: The minimum fixing temperature was 130° C. or higher but lower than 140° C.
Fair: The minimum fixing temperature was 140° C. or higher but lower than 150° C.
Poor: The minimum fixing temperature was 150° C. or higher.

### —High Temperature Release Properties—

IPSiO SP C220 available from Ricoh Company Limited was modified and the modified device was charged with the toner. The device was set in a manner that a deposition amount of the toner on Type 6000 (long grain) paper available from Ricoh Company Limited was to be 10 g/m², and the paper, on which an unfixed square solid image having a side of 40 mm was formed, was prepared.

Next, the prepared unfixed solid image was passed through a modified fixing unit of IPSiO SP 4510SF available from Ricoh Company Limited with setting system speed to 240 mm/sec, to thereby fix the image. The test was performed by varying the fixing temperature from 160° C. through 200° C. by 2° C. The output images were visually observed and the temperature at which unintentional toner transfer did not occur on the white background region was determined as the maximum fixing temperature. Evaluation criteria are as follows.

### [Evaluation Criteria]

Very good: The maximum fixing temperature was 210° C. or higher
Good: The maximum fixing temperature was 190° C. or higher but lower than 210° C.
Fair: The maximum fixing temperature was 170° C. or higher but lower than 190° C.
Poor: The maximum fixing temperature was lower than 170° C.

### <Evaluation of Cracking>

After charging a 250 mL plastic container with 50 g of the toner, 120 g of alumina beads having diameters of 10 mm were added to the container, and the toner was stirred for 44 hours at 150 rpm by means of a ball mill, to thereby produce a deteriorated toner for evaluation. The particle diameter of the toner before deterioration and the particle diameter of the toner after deterioration were measured by means of COULTER COUNTER Multisizer III and an increased amount of a small particle diameter component smaller than 3 μm was measured. The evaluation criteria are as follows.

### [Evaluation Criteria]

Very good: The increased amount was less than 4%.
Good: The increased amount was 4% or greater but less than 7%.
Fair: The increased amount was 7% or greater but less than 10%.
Poor: The increased amount was 10% or greater.

### <Evaluation of Blade Adhesion Resistance>

After charging a 250 mL plastic container with 50 g of the toner, 120 g of alumina beads having diameters of 10 mm were added to the container, and the toner was stirred for 40 hours at 150 rpm by means of a ball mill, to thereby produce a deteriorated toner for evaluation. A developing unit of IPSiO SP C220 available from Ricoh Company Limited was charged with 20 g of the deteriorated toner for the evaluation. An evaluation of blade adhesion was then performed by an external idle machine. The blade adhesion was confirmed every 5 minutes by visually observing lines derived from the adhesion in the areas of the developing roller of an image forming section where each area was positioned at 5 cm from each edge of the developing roller. The evaluation criteria are as follows.

### [Evaluation Criteria]

Very good: The timing for the blade adhesion to occur was 120 minutes or later.
Good: The timing for the blade adhesion to occur was 60 minutes or later but before 120 minutes.
Fair: The timing for the blade adhesion to occur was 30 minutes or later but before 60 minutes.
Poor: The timing for the blade adhesion to occur was before 30 minutes.

The evaluation results of Examples and Comparative Examples are presented in Table 8.

As a comprehensive evaluation, the case where the results of all of the evaluation items were “Good” or better was determined as “Very good,” the case where the results of all of the evaluation items were “Fair” or better was determined as “Good,” and the case where the results included one or more “Poor” was determined as “Poor.” “Good” and “Very good” are acceptable levels and “Very good” represents the better result than “Good.”

TABLE 8

| | | | Blade adhesion | | | | | | | | |
|---|---|---|---|---|---|---|---|---|---|---|---|
| | | | evaluation | | Fixing evaluation | | | | | | |
| | | | Timing | | Minimum | | Maximum | | Baclground smear | | Comprehensive |
| | | Cracking | (min) | Evaluation | (° C.) | Evaluation | (° C.) | Evaluation | L* ≥ 89.0 | Evaluation | evaluation |
| Ex. 3-1 | Toner 3-1 | Fair | 90 | Good | 120 | Very good | 175 | Fair | 91.4 | Very good | Good |
| Ex. 3-2 | Toner 3-2 | Very good | 125 | Very good | 135 | Good | 220 | Very good | 91.2 | Very good | Very good |
| Ex. 3-3 | Toner 3-3 | Fair | 75 | Good | 125 | Very good | 185 | Fair | 87.0 | Fair | Good |
| Ex. 3-4 | Toner 3-4 | Cood | 105 | Cood | 145 | Fair | 200 | Cood | 89.5 | Grad | Good |
| Ex. 3-5 | Toner 3-5 | Fair | 50 | Fair | 125 | Very good | 205 | Good | 85.3 | Fair | Good |
| Ex. 3-6 | Toner 3-6 | Good | 135 | Very good | 145 | Fair | 190 | Good | 91.4 | Very good | Good |
| Ex. 3-7 | Toner 3-7 | Good | 100 | Good | 145 | Fair | 195 | Good | 90.6 | Good | Good |
| Ex. 3-8 | Toner 3-8 | Fair | 45 | Fair | 125 | Verygood | 185 | Fair | 87.5 | Fair | Good |
| Ex. 3-9 | Toner 3-9 | Fair | 40 | Fair | 120 | Very good | 180 | Fair | 87.2 | Fair | Good |
| Ex. 3-10 | Toner 3-10 | Good | 100 | Good | 120 | Very good | 180 | Fair | 91.6 | Very good | Good |
| Ex. 3-11 | Toner 3-11 | Fair | 95 | Good | 120 | Very good | 175 | Fair | 91.2 | Very good | Good |
| By. 3-12 | Toner 3-12 | Fair | 35 | Fair | 120 | Very good | 180 | Fair | 87.0 | Fair | Good |
| Ex. 3-13 | Toner 3-13 | Good | 105 | Good | 120 | Very good | 175 | Fair | 91.7 | Very good | Good |
| Comp. | Comp. | Poor | 50 | Fair | 120 | Very good | 165 | Poor | 84.2 | Poor | Poor |
| Ex. 3-1 | Toner 3-1 | | | | | | | | | | |
| Comp. | Comp. | Grad | 100 | Cood | 155 | Poor | 220 | Very good | 84.6 | Poor | Poor |
| Ex. 3-2 | Toner 3-2 | | | | | | | | | | |
| Comp. | Comp. | Fair | 90 | Good | 145 | Fair | 165 | Poor | 88.0 | Fair | Poor |
| Ex. 3-3 | Toner 3-3 | | | | | | | | | | |
| Comp. | Comp. | Good | 105 | Good | 155 | Poor | 220 | Very good | 88.2 | Fair | Poor |
| Ex. 3-4 | Toner 3-4 | | | | | | | | | | |
| Comp. | Comp. | Fair | 25 | Poor | 120 | Very good | 185 | Fair | 87.5 | Fair | Poor |
| Ex. 3-5 | Toner 3-5 | | | | | | | | | | |
| Comp. | Comp. | Good | 110 | Good | 155 | Poor | 220 | Very good | 88.5 | Fair | Poor |
| Ex. 3-6 | Toner 3-6 | | | | | | | | | | |
| Comp. | Comp. | Poor | 20 | Poor | 120 | Very good | 190 | Good | 85.0 | Poor | Poor |
| Ex. 3-7 | Toner 3-7 | | | | | | | | | | |
| Comp. | Comp. | Good | 135 | Very good | 155 | Poor | 200 | Good | 88.1 | Fair | Poor |
| Ex. 3-8 | Toner 3-8 | | | | | | | | | | |
| Comp. | Comp. | Grad | 100 | Cood | 155 | Poor | 200 | Cood | 87.8 | Fair | Poor |
| Ex. 3-9 | Toner 3-9 | | | | | | | | | | |
| Comp. | Comp. | Fair | 25 | Poor | 125 | Very good | 165 | Poor | 87.5 | Fair | Poor |
| Ex. 3-10 | Toner 3-10 | | | | | | | | | | |
| Comp. | Comp. | Good | 135 | Very good | 155 | Poor | 200 | Good | 88.2 | Fair | Poor |
| Ex. 3-11 | Toner 3-11 | | | | | | | | | | |

For example, embodiments of the present disclosure are as follows.

<1> A toner including:
a binder resin,
wherein the toner includes a THF-insoluble component in an amount of from 10% by mass through 40% by mass,
a molecular weight distribution of a THF-soluble component of the toner measured by gel permeation chromatography (GPC) has a main peak between 10,000 and 16,000, and a half value width of the main peak is a molecular weight of from 60,000 through 90,000, and
the THF-soluble component of the toner includes a component having a molecular weight of 2,000 or less in an amount of from 15.0% by mass through 25.0% by mass, and a component having a molecular weight of 100,000 or greater in an amount of 10.0% by mass or less as measured by GPC.
<2> The toner according to <1>,
wherein the molecular weight distribution has a main peak between 12,000 and 15,000, and a half value width of the main peak is a molecular weight of from 65,000 through 80,000.
<3> The toner according to <1> or <2>,
wherein the toner includes the THF-insoluble component in an amount of from 30% by mass through 40% by mass.
<4> The toner according to any one of <1> to <3>, further including a release agent,
wherein an endothermic onset temperature of the release agent for second heating in differential scanning calorimetry (DSC) is 50° C. or higher but 75° C. or lower.
<5> The toner according to <4>,
wherein the endothermic onset temperature of the release agent is 55° C. or higher but 70° C. or lower.
<6> The toner according to any one of <1> to <3>, further including an azo iron compound.
<7> The toner according to <6>,
wherein the azo iron compound is represented by Structural Formula (1) below,

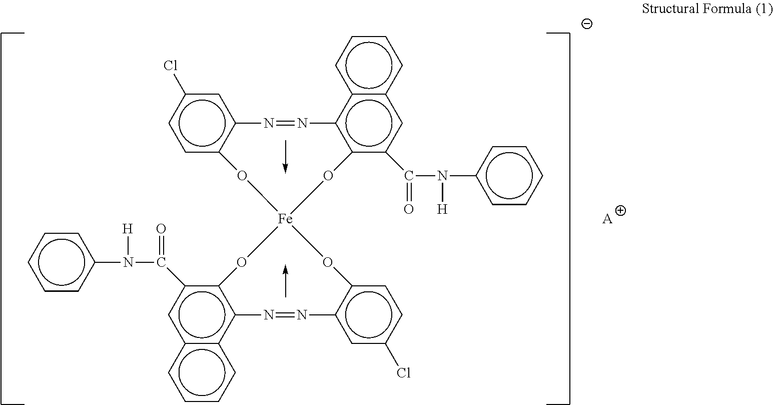

where, in Structural Formula (1), A⁺ is an ammonium ion.
<8> The toner according to any one of <1> to <7>,
wherein the toner is a toner for one-component development.
<9> A toner stored unit including:
a unit; and
the toner according to any one of <1> to <8> stored in the unit.
<10> An image forming apparatus including:
an electrostatic latent image bearer;
an electrostatic latent image forming unit configured to form an electrostatic latent image on the electrostatic latent image bearer; and
a developing unit configured to develop the electrostatic latent image formed on the electrostatic latent image bearer to form a visible image, where the developing unit includes a toner,
wherein the toner is the toner according to any one of <1> to <8>.

The present disclosure can solve the above-mentioned various problems existing in the art and can provide a toner having sufficient stress resistance with excellent fixability (low-temperature fixability and hot offset resistance) and not causing cracking or adhesion to a regulation blade even when the toner is used in one-component development.

What is claimed is:

1. A toner comprising:
a binder resin,
wherein the toner includes a THF-insoluble component in an amount of from 10% by mass through 40% by mass,
a molecular weight distribution of a THF-soluble component of the toner measured by gel permeation chromatography (G-PC) has a main peak between 10,000 and 16,000, and a half value width of the main peak is a molecular weight of from 60,000 through 90,000, and
the THF-soluble component of the toner includes a component having a molecular weight of 2,000 or less in an amount of from 15.0% by mass through 25.0% by mass, and a component having a molecular weight of 100,000 or greater in an amount of 10.0% by mass or less as measured by GPC.

2. The toner according to claim 1,
wherein the molecular weight distribution has a main peak between 12,000 and 15,000, and a half value width of the main peak is a molecular weight of from 65,000 through 80,000.

3. The toner according to claim 1,
wherein the toner includes the THF-insoluble component in an amount of from 30% by mass through 40% by mass.

4. The toner according to claim 1, further comprising a release agent, wherein an endothermic onset temperature of the release agent for second heating in differential scanning calorimetry (DSC) is 50° C. or higher but 75° C. or lower.

5. The toner according to claim 4,
wherein the endothermic onset temperature of the release agent is 55° C. or higher but 70° C. or lower.

6. The toner according to claim 1, further comprising an azo iron compound.

7. The toner according to claim 6,
wherein the azo iron compound is represented by Structural Formula (1) below, 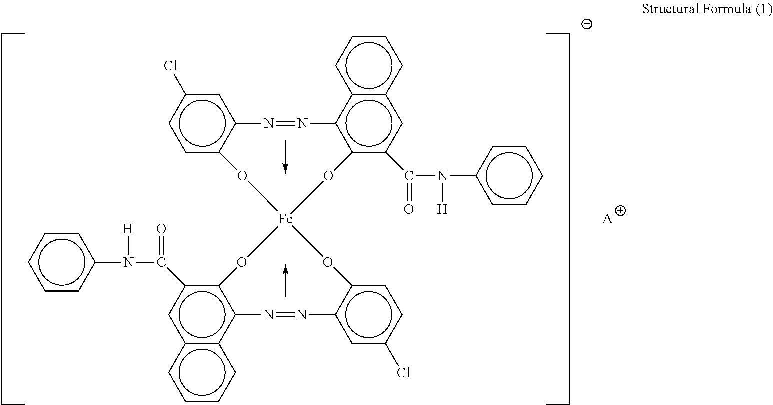
where, in Structural Formula (1), A⁺ is an ammonium ion.

8. The toner according to claim 1,
wherein the toner is a toner for one-component development.

9. A toner stored unit comprising:
a unit; and
the toner according to claim 1 stored in the unit.

10. An image forming apparatus comprising:
an electrostatic latent image bearer;
an electrostatic latent image forming unit configured to form an electrostatic latent image on the electrostatic latent image bearer; and
a developing unit configured to develop the electrostatic latent image formed on the electrostatic latent image bearer to form a visible image, where the developing unit includes a toner,
wherein the toner is the toner according to claim 1.
